(19) United States
(12) Patent Application Publication
(10) Pub. No.: US 2008/0039091 A1
(43) Pub. Date: Feb. 14, 2008

(54) COMMUNICATION RELAY APPARATUS, WIRELESS TERMINAL AND COMPUTER PROGRAM

(75) Inventors: Hidehiko Eguchi, Tokyo (JP); Tadayuki Fukuhara, Kanagawa (JP); Haruki Izumikawa, Kanagawa (JP)

Correspondence Address: MOTOROLA, INC., 1303 EAST ALGONQUIN ROAD, IL01/3RD, SCHAUMBURG, IL, 60196, US

(73) Assignees: MOTOROLA, INC., Schaumburg, IL (US); KDDI CORPORATION, Tokyo (JP)

(21) Appl. No.: 11/672,404

(22) Filed: Feb. 7, 2007

(30) Foreign Application Priority Data
Feb. 8, 2006 (JP) 2006-30659

(51) Int. Cl. H04Q 7/20

(52) U.S. Cl. 455/436

(57) ABSTRACT

In order to continue a communication by performing a handover across or between different communication systems, improvement in redundancy of a communication route and a delay time difference before and after switching the communication system is intended. A bicast entity 21 includes, when a wireless terminal 10 makes a connection and continues a communication across different communication systems 20X and 20Y, bicast means for delivering a packet for each communication route via each of the communication systems 20X and 20Y before and after switching the communication system to which the above described wireless terminal 10 connects, and control means for completing a relay of the packet when the switching of the communication system to which the above described wireless terminal 10 connects is completed.

### BACKGROUND OF THE INVENTION

1. Field of the Invention

The present invention relates to a communication relay apparatus, a wireless terminal and a computer program.

2. Description of the Related Art

In recent years, with the development of wireless communication technology, it has been possible to use an application having real time property, such as a videophone application or a video streaming delivery application, on a mobile terminal. In order to realize smooth usage of such a real time application, a technique for securing the real time property of the communication when a handover is performed, in which the mobile terminal switches abase station to which the mobile terminal connects, has been considered.

For example, in a technique described in “Seamless Handover in Mobile IP using SGM”, Institute of Electronics, Information and Communication Engineers, society convention in autumn, B-7-18, September 2001, under the condition in which the mobile terminal can connect to multiple connection points (access points and the base station), a gateway router (external agent) in an access network layered by using Mobile IP (Mobile Internet Protocol) records the multiple connection points of the mobile terminal. The gateway router converts only UDP packets to be used in many real time applications among packets destined for the mobile terminal to reproducible and explicit multicast packets if necessary at a router on the route, and sends the multicast packets. The above described multicast packets are delivered to the mobile terminal via the multiple connection points to which the mobile terminal connects. This prevents packet loss from occurring when the handover is performed and the like, while effectively utilizing network resources, and also secures the real time property in arrival of the packets. Moreover, in a technique described in Japanese Patent Laid-Open No. 2004-228754, at a home agent (HA) of Mobile IP, the multiple connection points of the mobile terminal are recorded, the packets are reproduced when the handover is performed, and the above described packets are sent to the multiple connection points, which prevents the packet loss from occurring when the handover is performed. In addition, in this related art, process load on the mobile terminal is reduced when multiple same packets have been received, and also degradation in performance of TCP (Transmission Control Protocol) communication due to receiving duplicated packets is improved, by attaching reproduction information to the packets when the packet reproduction is performed at the HA.

Incidentally, a mobile terminal has been considered which has communication means compliant with multiple wireless communication systems and switches its connection destination to an optimal wireless communication system depending on a wireless environment. For example, the mobile terminal is compliant with the multiple wireless communication systems providing communication services having different characteristics respectively, such as a cellular system, a PHS® system, a wireless LAN system and a wireless WAN system, and an optimal communication can be performed depending on the wireless environment, for example, such as by connecting to the cellular system having good connectivity during high-speed movement, and on the other hand, connecting to the wireless LAN system which enables a high speed communication during stopping. In addition, when the handover is performed between such heterogeneous systems, a technique for preventing interruption in the communication becomes important. For example, a technique described in Japanese Patent Laid-Open No. 2004-260444 selects a method to be used from among multiple handover methods, depending on the wireless communication system of a handover destination or a wireless communication state. For example, if the communication state is good before the handover and is not good after the handover, a soft handover for reproducing the same packet and sending it is employed, which realizes the handover without degrading receiving quality.

However, in the above described related art described in “Seamless Handover in Mobile IP using SGM” and Japanese Patent Laid-Open No. 2004-228754, the communication is always performed via the gateway router or the HA, which makes a communication route redundant and causes problems of wasted communication resources, network congestion due to flow concentration, increased load on network devices and the like.

Furthermore, with respect to the handover between the heterogeneous systems, since delay times may be significantly different between the heterogeneous systems, the techniques described in “Seamless Handover in Mobile IP using SGM” and Japanese Patent Laid-Open No. 2004-228754, which secure real time reachability of the packets, are effective between the same wireless communication systems, however, between the heterogeneous systems having significantly different delay times, a seamless handover may not be realized due to the delay time difference. Moreover, also in the technique described in Japanese Patent Laid-Open No. 2004-260444, when the handover is performed between the heterogeneous systems having significantly different delay times, performance may be degraded. This is a problem not only for the real time communication, but also for non real time communication using the TCP.

In addition, the technique described in Japanese Patent Laid-Open No. 2004-228754 intends to address a problem of an erroneous packet order by attaching the reproduction information to the packets. However, a process of attaching the reproduction information may reduce scalability.

Here, the above described problems will be specifically described.

First, the problem related to the redundant communication route will be described. FIG. 26 shows a conventional procedure in which a mobile terminal 100 performs the handover from a communication system 200X to a communication system 200Y. The mobile terminal 100 has communication interfaces for both of the communication systems 200X and 200Y to connect to the communication systems 200X and 200Y, so that the mobile terminal 100 can communicate with a communication partner terminal 400 connected to the Internet 300, for example. Moreover when the handover is performed between the communication systems 200X and 200Y, the mobile terminal 100 can connect to both of the communication systems 200X and 200Y to continue the communication.

In FIG. 26, first, the mobile terminal 100 is communicating with the communication partner terminal 400 via the communication system 200X, and a flow destined for the mobile terminal 100 has been routed to go through a bicast entity 210. Here, when the handover is expected to occur, for example, due to movement, the mobile terminal 100 informs the bicast entity 210 of the expectation of the handover and an identifier (IP address) of the above described mobile terminal 100 in the handover destination communication system 200Y. When the bicast entity 210 receives the information from the above described mobile terminal 100, the bicast entity 210 makes a copy of a packet destined for the mobile terminal 100, transfers one packet to the mobile terminal 100 via the communication system 200X, and also modifies a destination of the other packet to the identifier of the mobile terminal 100 in the handover destination communication system 200Y and transfers the other packet to the mobile terminal 100 via the communication system 200Y (a bicast state is established). When the handover to the communication system 200Y has been completed, the mobile terminal 100 informs the bicast entity 21 of the completion of the handover, and completes the bicast. However, in this conventional handover method, as shown in FIG. 27, the mobile terminal 100 continuously performs the communication via the bicast entity 210 placed in the communication system 200X also after the handover to the communication system 200Y has been completed. This makes the route redundant, and thereby the delay may increase and traffic congestion and the like may occur, which may degrade communication quality. This problem becomes significant particularly in the case of long distance between the communication systems.

Next, the problem caused by the different delay times between the communication systems will be described. In FIG. 26, for example, if the delay time attached in the communication system 200Y is less than the delay time attached in the communication system 200X, the packet received by the mobile terminal 100 via the communication system 200Y becomes a packet arriving earlier than the packet received via the communication system 200X, by the delay time difference between the both communication systems. In order to specifically describe this status, the following conditions are assumed in FIG. 26. The communication partner terminal 400 sends a packet attached with a sequence number, which increases one by one, every 100 msec to the mobile terminal 100. In addition, it is assumed that the delay time from the bicast entity 210 via the communication system 200X to the mobile terminal 100 is 800 msec, and the delay time from the bicast entity 210 via the communication system 200Y to the mobile terminal 100 is 200 msec (see FIG. 28).

In FIG. 28, first, it is assumed that the mobile terminal 100 is communicating with the communication partner terminal 400 via the communication system 200X, and at a time point T msec, the mobile terminal 100 has received the packets with the sequence numbers up to 100. It is also assumed that the mobile terminal 100 starts a handover process at the time point T msec. At this point, since the delay time from the bicast entity 210 via the communication system 200X to the mobile terminal 100 is 800 msec, the bicast entity 210 has received the packet with sequence number 108 from the communication partner terminal 400. When the handover process is started, the bicast entity 210 reproduces the packet with sequence number 108, sends one packet directly via the communication system 200X to the mobile terminal 100, and also modifies the destination of the other packet to the identifier of the mobile terminal 100 in the communication system 200Y and sends the other packet via the communication system 200Y to the mobile terminal 10. Next at a time point (T+200) msec, the mobile terminal 100 receives the packet from the communication system 200Y for the first time. This received packet is the first packet reproduced by the bicast entity 210, and has sequence number 108. Also at the same time point (T+200) msec, the mobile terminal 100 receives the packet with sequence number 102 from the communication system 200X. In this way, the packet sent from the communication partner terminal 400 earlier by 600 msec, which is the delay time difference between the both communication systems, arrives at the mobile terminal 100 via the communication system 200Y prior to the packet previously sent from the communication partner terminal 400, which causes inversion of a packet arrival order. It should be noted that delay of messages involved in the handover process, such as the information on the handover expectation, is omitted here for simplicity of explanation.

As the example of the above described FIG. 28, if the delay time of the route after the handover is less than the delay time of the route before the handover, particularly in a communication flow of the real time application (videophone and the like), a problem may be caused in which the communication flow is stopped and the like due to the inversion of the packet arrival order. For example, in the communication flow of the videophone, video or audio may be stopped for the delay time difference before and after the handover. In addition, also in a non real time application (file transfer and the like), in the case of the communication flow using congestion avoidance control of the TCP and the like, it is determined that the network congestion has occurred, due to the inversion of the packet arrival order, and congestion avoidance control retransmission is started, which reduces communication rate.

### SUMMARY OF THE INVENTION

The present invention has been made in view of these circumstances and an object of the present invention is to provide a communication relay apparatus and a wireless terminal with which, in the case of realizing continuation of a communication by performing a handover between different communication systems, improvement in redundancy of a communication route and a delay time difference before and after switching the communication system can be intended.

Moreover, it is another object of the present invention to provide a computer program for using a computer to realize the communication relay apparatus of the present invention.

In order to address the above described problems, the communication relay apparatus according to the present invention is a communication relay apparatus for, when a wireless terminal makes a connection and continues a communication across (when switching between) different communication systems, temporarily delivering a packet of the above described communication, including bicast means for delivering the above described packet for each communication route via each communication system before and after switching the communication system to which the above described wireless terminal connects, and control means for completing a relay of the above described packet when the switching of the communication system to which the above described wireless terminal connects is completed.

In the communication relay apparatus according to the present invention, the above described bicast means has delay adjustment means for evaluating a delay time in each communication route before and after switching the communication system to which the above described wireless terminal connects, and adjusting a difference in the delay times.

In the communication relay apparatus according to the present invention, when the adjustment of the above described difference in the delay times has been completed, the above described control means reroutes to an optimal communication route via a switch destination communication system for the above described wireless terminal.

The wireless terminal according to the present invention is a wireless terminal for making a connection and continuing a communication across different communication systems, including communication control means for establishing, for each communication route via each communication system before and after switching the communication system, a communication route to and from a communication relay apparatus for delivering a packet, wherein after the communication via the above described communication relay apparatus is performed, the above described communication control means reroutes to an optimal communication route via a switch destination communication system.

The computer program according to the present invention is a computer program for performing a communication control process when a wireless terminal makes a connection and continues a communication across different communication systems, the above described computer program causing a computer to realize a bicast function of delivering a packet for each communication route via each communication system before and after switching the communication system to which the above described wireless terminal connects, and a control function of completing a relay of the above described packet when the switching of the communication system to which the above described wireless terminal connects is completed.

In the computer program according to the present invention, the computer program further causes the computer to realize a delay adjustment function of evaluating a delay time in each communication route before and after switching the communication system to which the above described wireless terminal connects, and adjusting a difference in the delay times.

In the computer program according to the present invention, when the adjustment of the above described difference in the delay times has been completed, the above described control function reroutes to an optimal communication route via a switch destination communication system for the above described wireless terminal.

According to the present invention, when the wireless terminal makes the connection and continues the communication across the different communication systems, a smooth handover can be realized and high communication quality of a real time application and the like can be maintained.

Moreover, redundant communication routes are temporarily used during the handover, which enables effective usage of communication resources.

In addition, the evaluation of the delay time before and after switching the communication route, and the adjustment of the delay time difference make it possible to intend to solve problems caused by the delay time difference before and after switching the communication system, by preventing inversion of a packet arrival order, reducing a rapid change in the delay time, and the like.

### BRIEF DESCRIPTION OF THE DRAWINGS

FIG. 1 is a block diagram showing a general configuration of a communication system according to a first embodiment of the present invention;

FIG. 2 shows routes between respective nodes in a network configuration shown in FIG. 1;

FIG. 3 is a process sequence diagram among devices according to the first embodiment of the present invention;

FIG. 4 is a process sequence diagram among the devices according to the first embodiment of the present invention;

FIG. 5 is a process sequence diagram among the devices according to the first embodiment of the present invention;

FIG. 6 is a process sequence diagram among the devices according to the first embodiment of the present invention;

FIG. 7 is a process sequence diagram among the devices according to the first embodiment of the present invention;

FIG. 8 is a flowchart showing a handover procedure according to the first embodiment of the present invention;

FIG. 9 is a flowchart showing the handover procedure according to the first embodiment of the present invention;

FIG. 10 is a sequence diagram in a network driven case according to the first embodiment of the present invention;

FIG. 11 is a sequence diagram in the network driven case according to the first embodiment of the present invention;

FIG. 12 is a sequence diagram in the network driven case according to the first embodiment of the present invention;

FIG. 13 is a sequence diagram in the network driven case according to the first embodiment of the present invention;

FIG. 14 is a flowchart of a handover procedure in the network driven case according to the first embodiment of the present invention;

FIG. 15 is a block diagram showing a general configuration of a communication system according to a second embodiment of the present invention;

FIG. 16 shows routes between respective nodes in a network configuration shown in FIG. 15;

FIG. 17 is a process sequence diagram among devices according to the second embodiment of the present invention;

FIG. 18 is a process sequence diagram among the devices according to the second embodiment of the present invention;

FIG. 19 is a process sequence diagram among the devices according to the second embodiment of the present invention;

FIG. 20 is a process sequence diagram among the devices according to the second embodiment of the present invention;

FIG. 21 is a flowchart showing a handover procedure according to the second embodiment of the present invention;

FIG. 22 is a sequence diagram in a network driven case according to the second embodiment of the present invention;

FIG. 23 is a sequence diagram in the network driven case according to the second embodiment of the present invention;

FIG. 24 is a sequence diagram in the network driven case according to the second embodiment of the present invention;

FIG. 25 is a sequence diagram in the network driven case according to the second embodiment of the present invention;

FIG. 26 illustrates a conventional handover procedure between different communication systems;

FIG. 27 illustrates the conventional handover procedure between the different communication systems; and

FIG. 28 illustrates the conventional handover procedure between the different communication systems.

### DETAILED DESCRIPTION OF THE PREFERRED EMBODIMENTS

Hereinafter each embodiment of the present invention will be described sequentially with reference to the figures. It should be noted that the embodiments described below will be described with an example of a communication system for processing communication flows using SIP (Session Initiation Protocol). The SIP is a communication control protocol used mainly in the case of handling real time traffic.

### First Embodiment

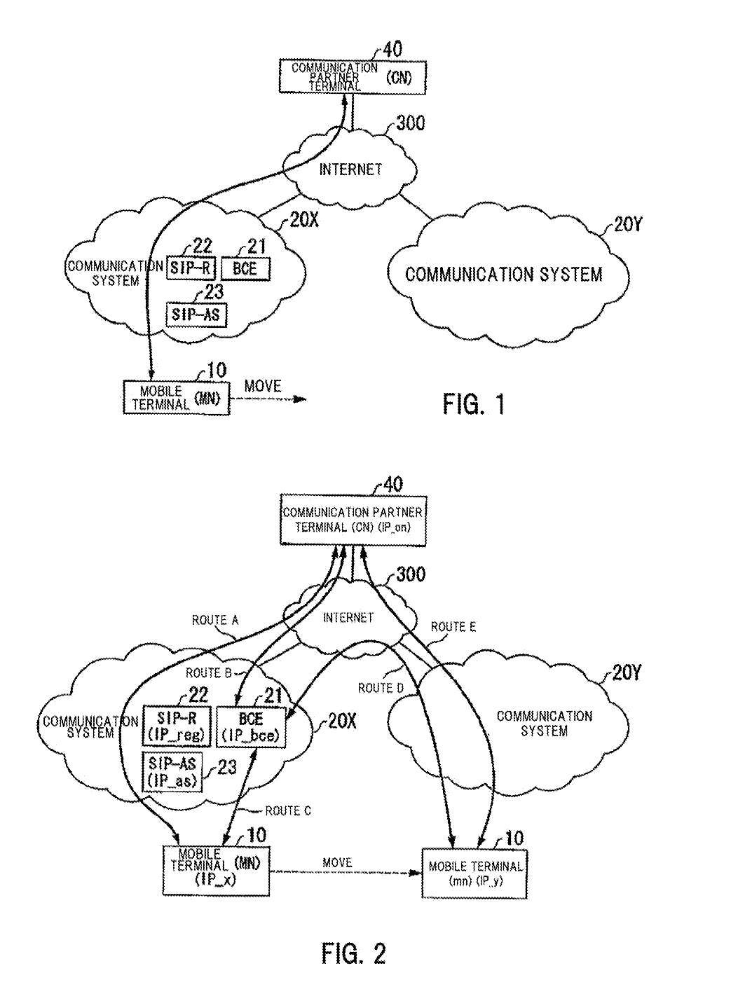

FIG. 1 is a block diagram showing a general configuration of a communication system according to a first embodiment of the present invention. In FIG. 1, a communication system 20X has a bicast entity (BCE) 21, a SIP registrar server (SIP-R) 22 and a SIP application server (SIP-AS) 23. The BCE 21, the SIP-R 22 and the SIP-AS 23 are configured to operate within the same node or operate in very close coordination. Moreover, the BCE 21 may be placed in a media gateway or in a home gateway at a user's home.

In FIG. 1, a mobile terminal (MN) 10 has communication interfaces for both of the communication system 20X and a communication system 20Y to connect to the communication systems 20X and 20Y, so that the MN 10 can communicate with a communication partner terminal (CN) 40 connected to the Internet 300, for example. Moreover, when a handover is performed between the communication systems 20X and 20Y, the MN 10 can connect to both of the communication systems 20X and 20Y to continue the communication.

Here for convenience of explanation, it is assumed that an IP address assigned to the communication interface for the communication system 20X included in the MN 10 (hereinafter referred to as “MN 10_X”) is IP_x, and an IP address assigned to the communication interface for the communication system 20Y included in the MN 10 (hereinafter referred to as “MN 10_Y”) is IP_y. Similarly, it is assumed that an IP address of the BCE 21 is IP_bce, an IP address of the SIP-R 22 is IP_reg, an IP address of the SIP-AS 23 is IP_as, and an IP address of the CN 40 is IP_cn. In addition, it is assumed that a SIP URI (SIP Uniform Resource Identifier) of the MN 10 is “MN@example.net”, and a SIP URI of the CN 40 is “CN@example.net”. It should be noted that the CN 40 is a legacy terminal implemented with the SIP in this embodiment.

FIG. 2 shows routes between respective nodes in a network configuration shown in the above described FIG. 1. A communication route between the CN 40 and the MN 10_X (not via the BCE 21) is a route A, a communication route between the CN 40 and the BCE 21 is a route B, a communication route between the BCE 21 and the MN 10_X is a route C, a communication route between the BCE 21 and the MN 10_Y is a route D, and a communication route between the CN 40 and the MN 10_Y (not via the BCE 21) is a route E. Moreover, respective delay times in the routes A, B, C, D and E are Dly_A, Dly_B, Dly_C, Dly_D and Dly_E.

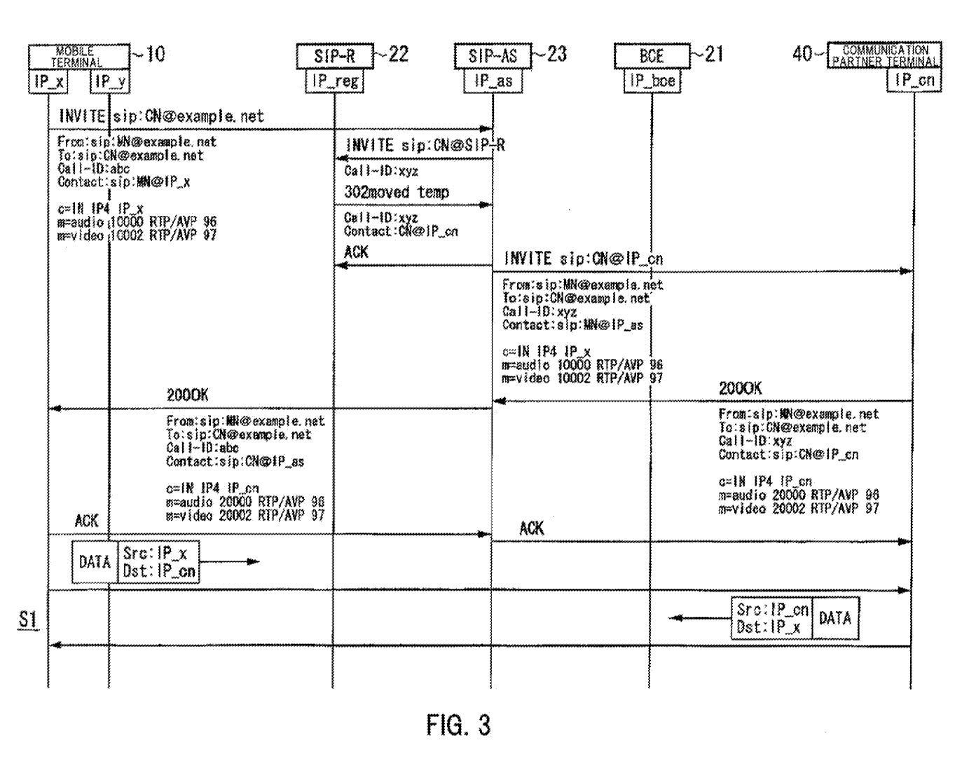

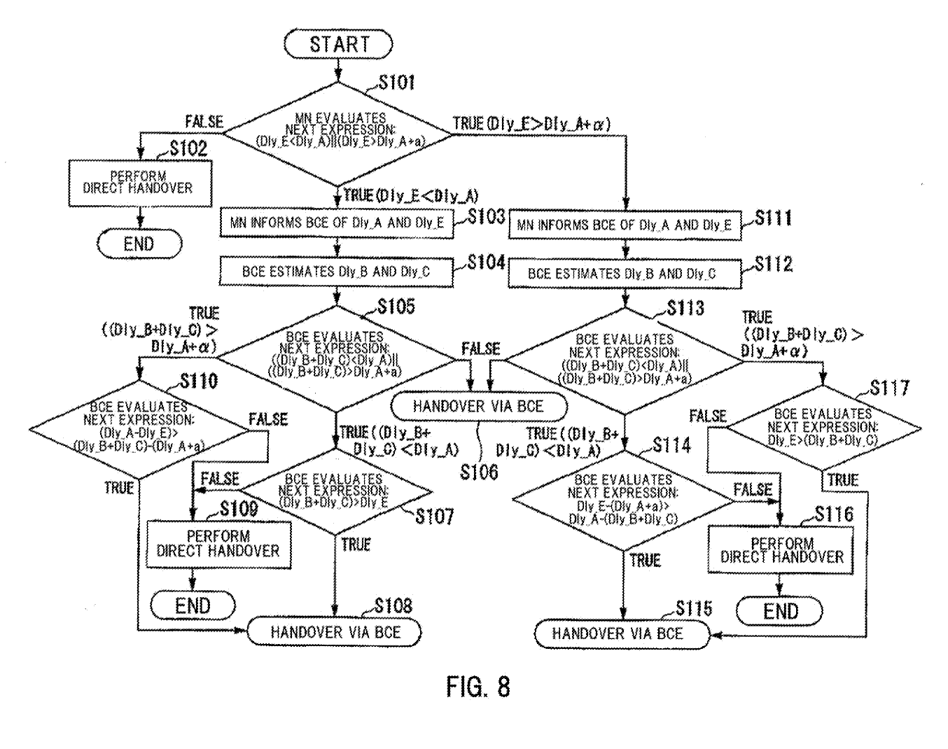

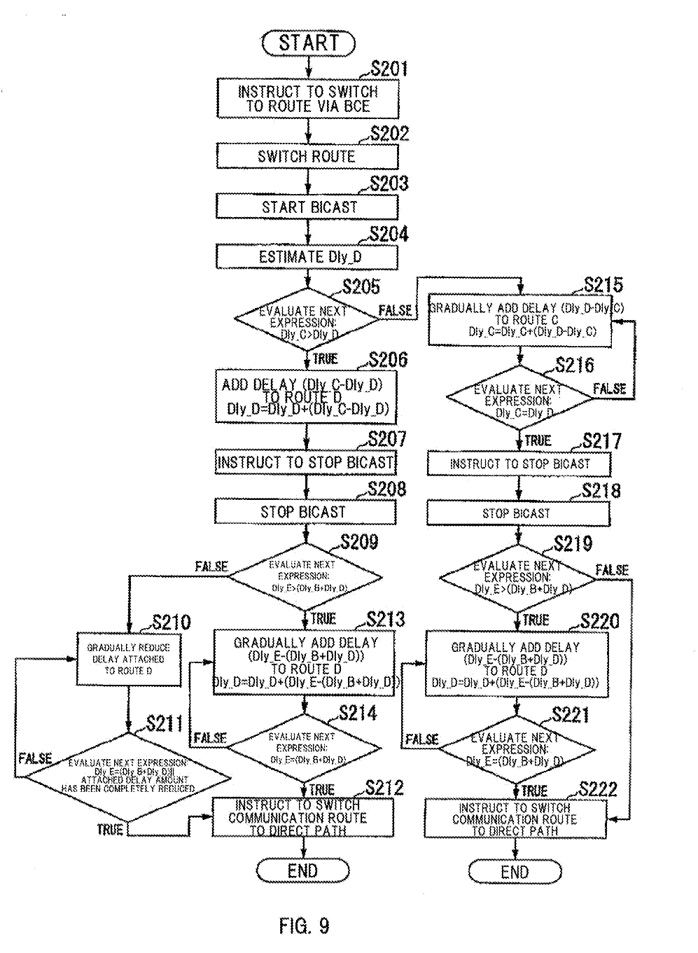

Next with reference to FIG. 2 and FIGS. 3 to 9, operations according to the first embodiment will be described. FIGS. 3 to 7 are process sequence diagrams among devices according to the first embodiment, and FIGS. 8 and 9 are flowcharts showing a handover procedure according to the first embodiment.

In FIG. 2, the MN 10 first connects to the communication system 20X to communicate with the CN 40 through the route A, then performs the handover for switching the network to connect from the communication system 20X to the communication system 20Y, and continues the communication with the CN 40 via the communication system 20Y. The operation related to this handover will be described below.

First, according to an SIP procedure shown in FIG. 3, the MN 10 uses the communication system 20X to establish a session with the CN 40, and performs the communication by using a communication application, for example, such as an IP videophone (step S1 in FIG. 3). At this point, in a packet sent from the MN 10, a sender address is IP_x and a destination address is IP_cn. Also, in a packet sent from the CN 40, a sender address is IP_cn and a destination address is IP_x.

At this point, if the handover is expected to occur, for example, due to a handover trigger from a link layer, a handover instruction from the network or the like, the MN 10 and the BCE 21 determine whether or not the handover by using the BCE 21 is performed according to a procedure shown in FIG. 8. Here, with reference to FIG. 8, a process of the determination of whether or not the handover by using the BCE 21 is performed will be described.

In FIG. 8, the MN 10 first compares Dly_A with Dly_E (step S101 in FIG. 8). Dly_A and Dly_E are calculated by the MN 10 from a result of measuring communication delay times by using exchange of the packets using a ping command or a time stamp and the like. As a result of the comparison at step S101, if Dly_E is greater than Dly_A and less than “Dly_A+α”, that is, Dly_A supplemented with a certain amount α (FALSE at step S101), a normal handover without using the BCE 21 is performed (step S102). The normal handover without using the BCE 21 (direct handover) refers to a process of directly switching the communication route between the CN 40 and the MN 10 from the route A to the route E. In this case, the normal handover is performed because no inversion of a packet arrival order occurs since the route E has the delay time greater than that in the route A, and also because a difference between those delay times is small and therefore the switching has no problematic effect on the continuation of the communication. It should be noted that a delay amount which can be absorbed by a real time application or the like is used for α.

In the case where Dly_E is less than Dly_A in the comparison result at step S101]

The MN 10 informs the BCE 21 of Dly_A and Dly_E (step S103). Also, the BCE 21 calculates Dly_B and Dly_C from the measurement (step S104). Next, the BCE 21 compares “Dly_B+Dly_C” with Dly_A (step S105) Here, the delay time between the CN 40 and the MN 10_X via the BCE 21 and the delay time in the route A are evaluated. As a result of the comparison at step S105, if “Dly_B+Dly_C” is greater than Dly_A and less than “Dly_A+α” (FALSE at step S105), it is determined that the handover by using the BCE 21 is performed (step S106). This is because the communication route via the BCE 21 (the routes B and C) is used to adjust the delay time and prevent the inversion of the packet arrival order, since the route E has the delay time less than that in the route A.

As the result of the comparison at step S105, if “Dly_B+Dly_C” is less than Dly_A, “Dly_B+Dly_C” is compared with Dly_E (step S107). As a result of the comparison at step S107, if “Dly_B+Dly_C” is greater than Dly_E (TRUE at step S107), it is determined that the handover by using the BCE 21 is performed (step S108). This is because the communication route via the BCE 21 (the routes B and C) has less delay time difference with the route A. On the other hand, as the result of the comparison at step S107, if “Dly_B+Dly_C” is less than Dly_E (FALSE at step S107), the normal handover is performed (step S109).

As the result of the comparison at step S105, if “Dly_B+Dly_C” is greater than “Dly_A+α”, a difference between Dly_A and Dly_E is compared with a difference between “Dly_B+Dly_C” and “Dly_A+α” (step S110). As a result of the comparison at step S110, if the difference between Dly_A and Dly_E is greater than the difference between “Dly_B+Dly_C” and “Dly_A+α” (TRUE at step S110), it is determined that the handover by using the BCE 21 is performed (step S108). This is because the normal handover has greater delay time difference with the route A. On the other hand, as the result of the comparison at step S110, if the difference between Dly_A and Dly_E is less than the difference between “Dly_B+Dly_C” and “Dly_A+α” (FALSE at step S110), the normal handover is performed (step S109).

In the case where Dly_E is greater than “Dly_A+α” in the comparison result at step S101]

The MN 10 informs the BCE 21 of Dly_A and Dly_E (step S111). Also, the BCE 21 calculates Dly_B and Dly_C from the measurement (step S112). Next, the BCE 21 compares “Dly_B+Dly_C” with Dly_A (step S113). As a result of the comparison at step S113, if “Dly_B+Dly_C” is greater than Dly_A and less than “Dly_A+α” (FALSE at step S113), it is determined that the handover by using the BCE 21 is performed (step S106). This is because although no inversion of the packet arrival order occurs by performing the normal handover since the route E has the delay time greater than that in the route A, the communication route via the BCE 21 (the routes B and C) is used to adjust the delay time and prevent a rapid change in the delay time.

As the result of the comparison at step S113, if “Dly_B+Dly_C” is less than Dly_A, a difference between Dly_E and “Dly_A+α” is compared with a difference between Dly_A and “Dly_B+Dly_C” (step S114). As a result of the comparison at step S114, if the difference between Dly_E and “Dly_A+α” is greater than the difference between Dly_A and “Dly_B+Dly_C” (TRUE at step S114), it is determined that the handover by using the BCE 21 is performed (step S115). This is because the normal handover has greater delay time difference with the route A. On the other hand, as the result of the comparison at step S114, if the difference between Dly_E and “Dly_A+α” is less than the difference between Dly_A and “Dly_B+Dly_C” (FALSE at step S114), the normal handover is performed (step S116).

As the result of the comparison at step S113, if “Dly_B+Dly_C” is greater than “Dly_A+α”, “Dly_B+Dly_C” is compared with Dly_E (step S117). As a result of the comparison at step S117, if “Dly_B+Dly_C” is less than Dly_E (TRUE at step S117), it is determined that the handover by using the BCE 21 is performed (step S115). This is because the delay time in the communication route via the BCE 21 (the routes B and C) has less delay time difference with “Dly_A+α”. On the other hand, as the result of the comparison at step S117, if “Dly_B+Dly_C” is greater than Dly_E (FALSE at step S117), the normal handover is performed (step S116).

Next, with reference to FIG. 9, a handover process by using the BCE 21 will be described.

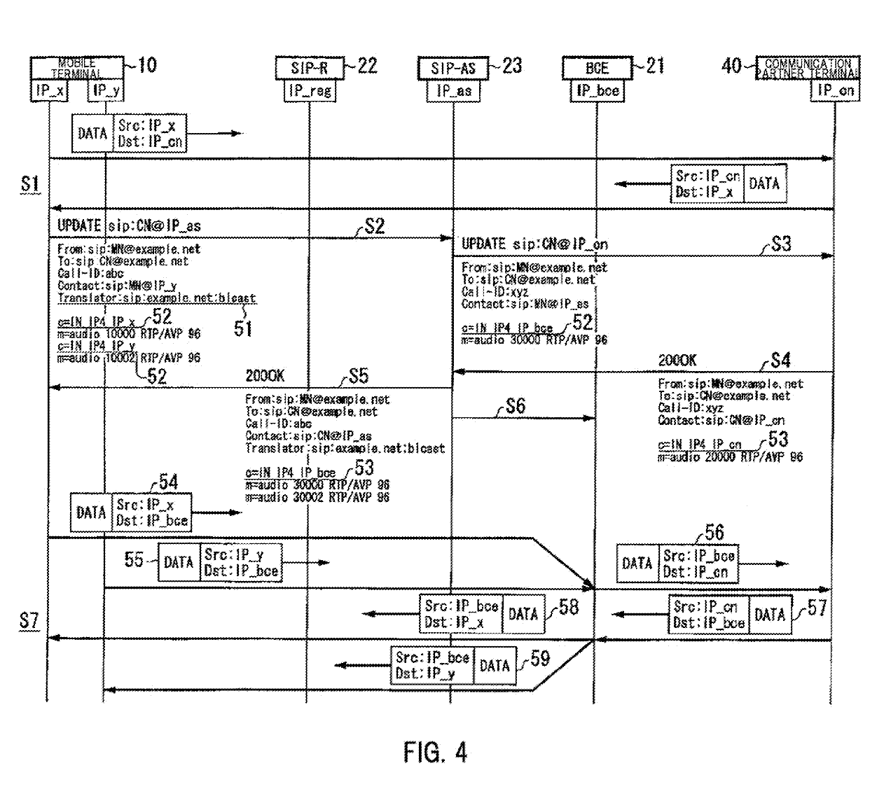

In FIG. 9, the BCE 21 instructs the MN 10 to switch the communication route to the route via the BCE 21 (step S201). When the MN 10 receives the instruction, the MN 10 switches the communication route to the route via the BCE 21 (step S202), and performs a bicast request (step S203). FIG. 4 shows a sequence at this point (steps S2 to S6 in FIG. 4) In this embodiment, as shown in FIG. 4, the bicast request is performed by using an UPDATE message of the SIP. In the UPDATE message, a header field of the SIP is extended to define a header field name “Translator”, and a string “bicast” indicating that the message is the bicast request is included in a “Translator” header field 51.

In FIG. 4, when the SIP-AS 23 receives the UPDATE message including the string “bicast” in its “Translator” header field 51, the SIP-AS 23 instructs the BCE 21 to start data transmission destined for the IP addresses (in this case, destined for both of the addresses IP_x and IP_y) described in “c (connection information)” fields 52 in a “Session Description” section in the above described UPDATE message (step S6). This establishes a bicast state. Also, when the SIP-AS 23 sends the above described UPDATE message to the CN 40 (step S3), the SIP-AS 23 integrates the “c” fields 52 in the “Session Description” field into one field and stores IP_bce as its IP address therein. Also similarly, when the SIP-AS 23 receives a 200OK message which is a response with respect to the above described UPDATE message (step S4), the SIP-AS 23 modifies the IP address described in a “c” field 53 in the “Session Description” field in the above described 200OK message to IP_bce, and sends the message to the MN 10 (step S5).

Next, the MN 10 reproduces the packet. With respect to one packet 54, the MN 10 sets its sender IP address to IP_x and its destination IP address to IP_bce and sends the packet from the MN 10_X. With respect to the other packet 55, the MN 10 sets its sender IP address to IP_y and its destination IP address to IP_bce and sends the packet from the MN 10_Y.

When the BCE 21 receives these packets 54 and 55, the BCE 21 modifies the sender address to IP_bce and the destination address to IP_cn in the packets 54 and 55, and sends a modified packet 56 to the CN 40. At this point, the BCE 21 sends the packet which has arrived first, and discards the same packet which has arrived later. For example, this discarding process can be realized by discriminating whether or not they are the same packet by referring to a sequence number in an RTP (Realtime Transport Protocol) header and the like.

On the other hand, in a packet 57 sent from the CN 40, its sender address is IP_cn and its destination address is IP_bce. When the BCE 21 receives the packet 57 sent from the CN 40, the BCE 21 reproduces the packet 57. With respect to one packet 58, the BCE 21 sets its sender address to IP_bce and its destination address to IP_x, and with respect to the other packet 59, sets its sender address to IP_bce and its destination address to IP_y. Then the BCE 21 sends the packets to the MN 10 respectively.

This establishes the bicast state between the MN 10 and the CN 40 in which two communication routes, that is, the communication route using the routes B and C and the communication route using the routes B and D are established (step S7).

Returning to FIG. 9, next the BCE 21 calculates Dly_D from the measurement (step S204), and compares Dly_C with Dly_D (step S205). As a result of the comparison at step S205, if Dly_C is greater than Dly_D (TRUE at step S205), the BCE 21 controls the packet transmission so that the delay time of “Dly_C-Dly_D”, which is a difference between Dly_C and Dly_D, is attached to the packet to be sent to the route D (step S206) This sets the delay time from the BCE 21 through the route C until arriving at the MN 10_X equal to the delay time from the BCE 21 through the route D until arriving at the MN 10_Y.

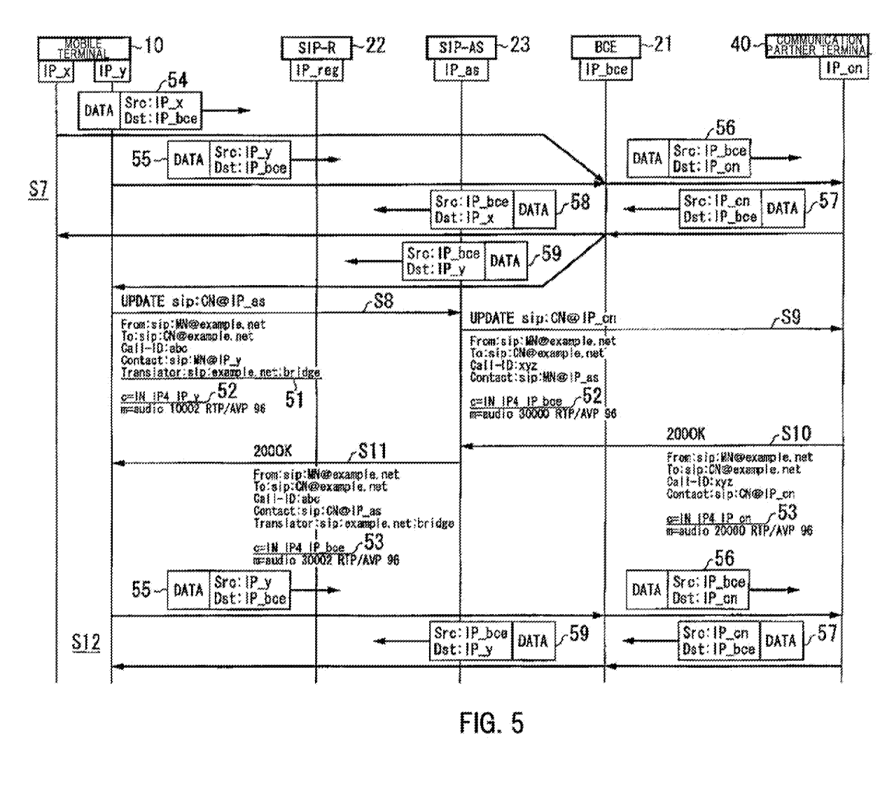

Next, the BCE 21 instructs the MN 10 to stop the bicast (step S207). When the MN 10 receives the instruction for stopping the bicast, the MN 10 requests the BCE 21 to stop the bicast (step S208). FIG. 5 shows a sequence at this point (steps S8 to S11 in FIG. 5) In this embodiment, as shown in FIG. 5, the bicast stop request is performed by using the UPDATE message of the SIP (step S8). In the UPDATE message, a string “bridge” indicating that the message is the bicast stop request is included in the “Translator” header field 51.

In FIG. 5, if the SIP-AS 23 has received the UPDATE message including the string “bridge” in its “Translator” header field 51, when the SIP-AS 23 sends the above described UPDATE message to the CN 40 (step S9), the SIP-AS 23 modifies the IP address described in the “c” field 52 in the “Session Description” section to IP_bce. Also similarly, when the SIP-AS 23 receives the 200OK message which is the response with respect to the above described UPDATE message (step S10), the SIP-AS 23 modifies the IP address described in the “c” field 53 in the “Session Description” field in the above described 200OK message to IP_bce, and sends the message to the MN 10 (step S11).

This changes the state between the MN 10 and the CN 40 from the bicast state in which two communication routes, that is, the communication route using the routes B and C and the communication route using the routes B and D are established, to a state in which only the communication route using the routes B and D is established (step S12).

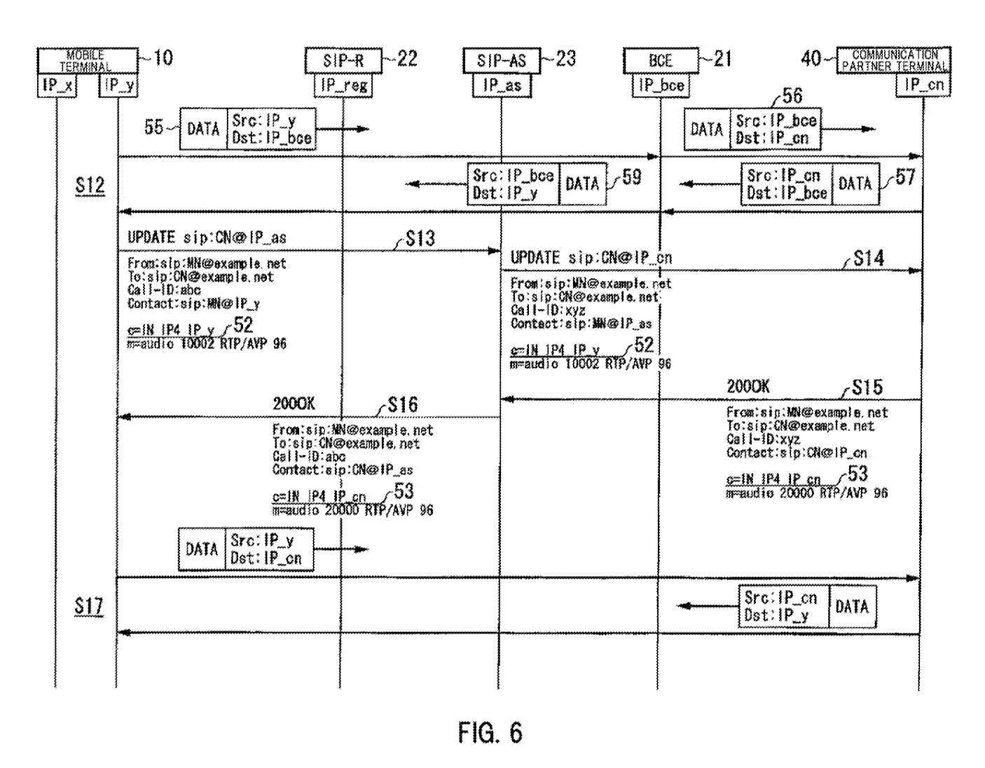

Returning to FIG. 9, next the BCE 21 compares Dly_E with “Dly_B+Dly_D” (step S209). As a result of the comparison at step S209, if Dly_E is less than “Dly_B+Dly_D” (FALSE at step S209), the BCE 21 gradually reduces the delay time which the BCE 21 has attached to the packet to be sent to the route D at step S206 (step S210). The BCE 21 evaluates the result (step S211), and if Dly_E becomes equal to “Dly_B+Dly_D”, or the delay time which the BCE 21 has attached to the packet to be sent to the route D at step S206 has been completely reduced, the BCE 21 instructs the MN 10 to switch the communication route to a direct route (route E) between the CN 40 and the MN 10_Y (step S212). When the MN 10 receives this switching instruction, the MN 10 uses the UPDATE message of the SIP as shown in FIG. 6 to switch the route between the CN 40 and the MN 10_Y from the route via the BCE 21 to the direct route (route E) (steps S13 to S16 in FIG. 6).

This changes the state between the MN 10 and the CN 40 from the state in which the communication route via the BCE 21 using the routes B and D is established, to the state in which the direct route with the route E is established (step S17).

On the other hand, as the result of the comparison at step S209, if Dly_E is greater than “Dly_B+Dly_D” (TRUE at step S209), the BCE 21 further gradually add “Dly_E-(Dly_B+Dly_D)”, which is a difference between them, to the delay time which the BCE 21 has attached to the packet to be sent to the route D at step S206 (step S213). The BCE 21 evaluates the result (step S214), and if “Dly_B+Dly_D” becomes equal to Dly_E, the BCE 21 instructs the MN 10 to switch the communication route to the direct route (route E) between the CN 40 and the MN 10 (step S212). With steps S13 to S16 in FIG. 6, this changes the state between the MN 10 and the CN 40 from the state in which the communication route via the BCE 21 using the routes B and D is established, to the state in which the direct route with the route E is established (step S17 in FIG. 6).

In the case where Dly_C is less than Dly_D in the comparison result at step S205 (FALSE at step S205)] (the bicast state has been established between the MN 10 and the CN 40 in which two communication routes, that is, the communication route using the routes B and C and the communication route using the routes B and D are established)

The BCE 21 controls the packet transmission so that the delay time of “Dly_D-Dly_C” is gradually attached to the packet to be sent to the route C (step S215). As a result, when the delay time in the route C “Dly_C” becomes equal to the delay time in the route D “Dly_D” (TRUE at step S216), the BCE 21 instructs the MN 10 to stop the bicast, the MN 10 requests to stop the bicast, and the BCE 21 stops the bicast (see steps S217 and S218, and FIG. 5). This changes the state between the MN 10 and the CN 40 from the bicast state in which two communication routes, that is, the communication route using the routes B and C and the communication route using the routes B and D are established, to the state in which only the communication route using the routes B and D is established (step S12 in FIG. 5).

Next, the BCE 21 compares Dly_E with “Dly_B+Dly_D” (step S219). As a result of the comparison at step S219, if Dly_E is less than “Dly_B+Dly_D” (FALSE at step S219), the BCE 21 instructs the MN 10 to switch the communication route to the direct route (route E) between the CN 40 and the MN 10 (step S222). With steps S13 to S16 in FIG. 6, this changes the state between the MN 10 and the CN 40 from the state in which the communication route via the BCE 21 using the routes B and D is established, to the state in which the direct route with the route E is established (step S17 in FIG. 6).

On the other hand, as the result of the comparison at step S219, if Dly_E is greater than “Dly_B+Dly_D” (TRUE at step S219), the BCE 21 controls the packet transmission so that “Dly_E-(Dly_B+Dly_D)”, which is a difference between them is gradually attached to the packet to be sent to the route D (step S220). As a result, when “Dly_B+Dly_D” becomes equal to Dly_E (TRUE at step S221), the BCE 21 instructs the MN 10 to switch the communication route to the direct route (route E) between the CN 40 and the MN 10 (step S222). With steps S13 to S16 in FIG. 6, this changes the state between the MN 10 and the CN 40 from the state in which the communication route via the BCE 21 using the routes B and D is established, to the state in which the direct route with the route E is established (step S17 in FIG. 6).

According to the above described first embodiment, it is possible to limit usage of the communication route via the bicast entity to temporary usage during the handover, and perform the communication by using an optimal communication route not via the bicast entity after the handover is completed. This improves redundancy of the communication route in the case of realizing the continuation of the communication by performing the handover between different communication systems.

Moreover, evaluation of the delay time before and after switching the communication route, and adjustment of the delay time difference can prevent the inversion of the packet arrival order and also reduce the rapid change in the delay time. Although this embodiment increases the number of times of switching the communication route in comparison to the related art, the delay adjustment of this embodiment can reduce the effect of the change in delay due to the increased number of times of switching.

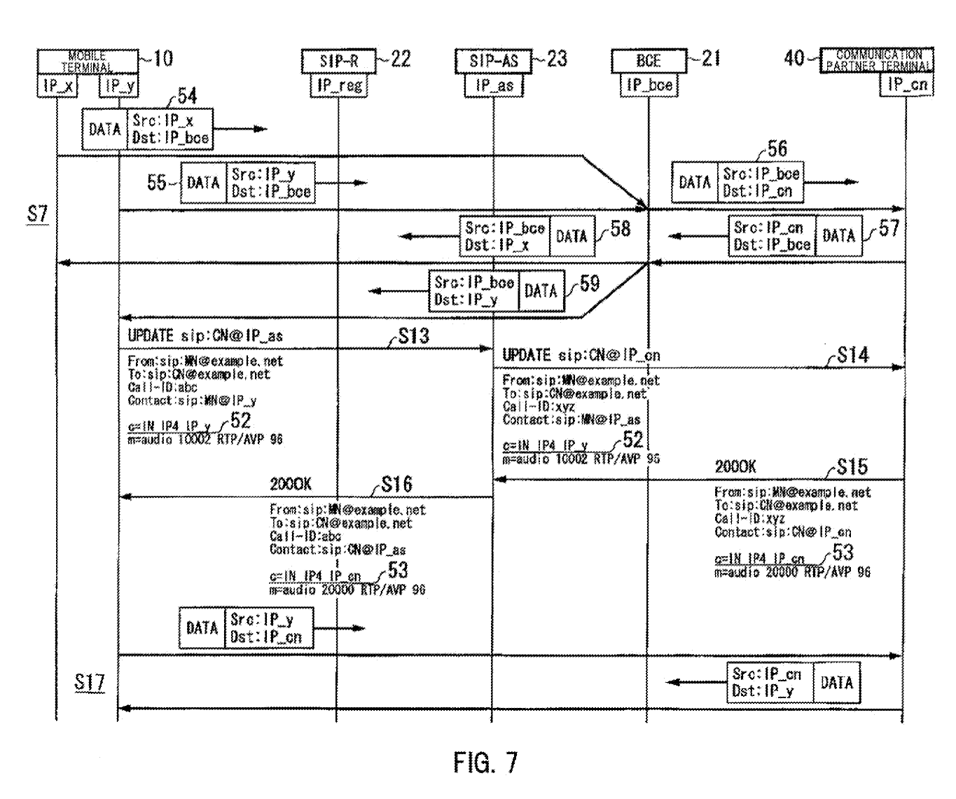

It should be noted that, in the above described embodiment, if the delay amounts “Dly_B+Dly_C”, “Dly_B+Dly_D” and Dly_E are previously measured, and as the result, all of them are approximately the same value, the adjustment of the delay time is not required, and therefore, from the bicast state, the bicast may be stopped and the switching to the direct route may be performed at once. FIG. 7 shows a sequence at this point. In FIG. 7, the state is changed from the bicast state (step S7) to the state in which the direct route is established (step S17), with steps S13 to S16.

Also, although it is assumed to use the real time application in the above described embodiment, in the case of a non real time application, for example, degradation in communication quality due to an erroneous packet order in the communication using TCP and the like can be prevented by setting the above described α to a sufficiently great value.

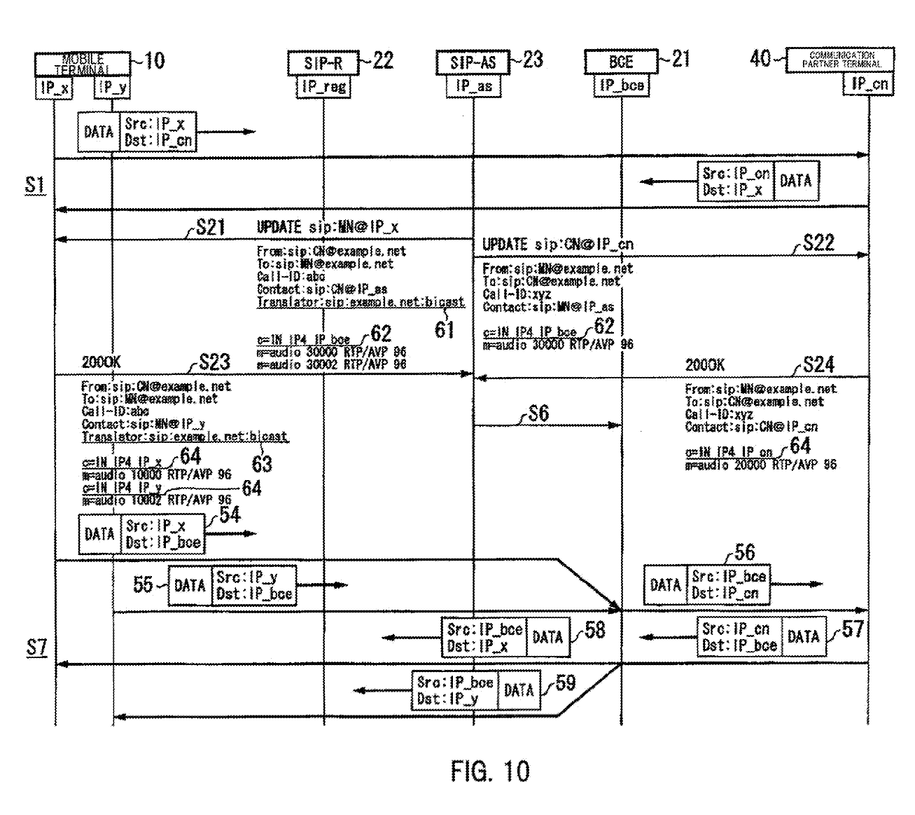

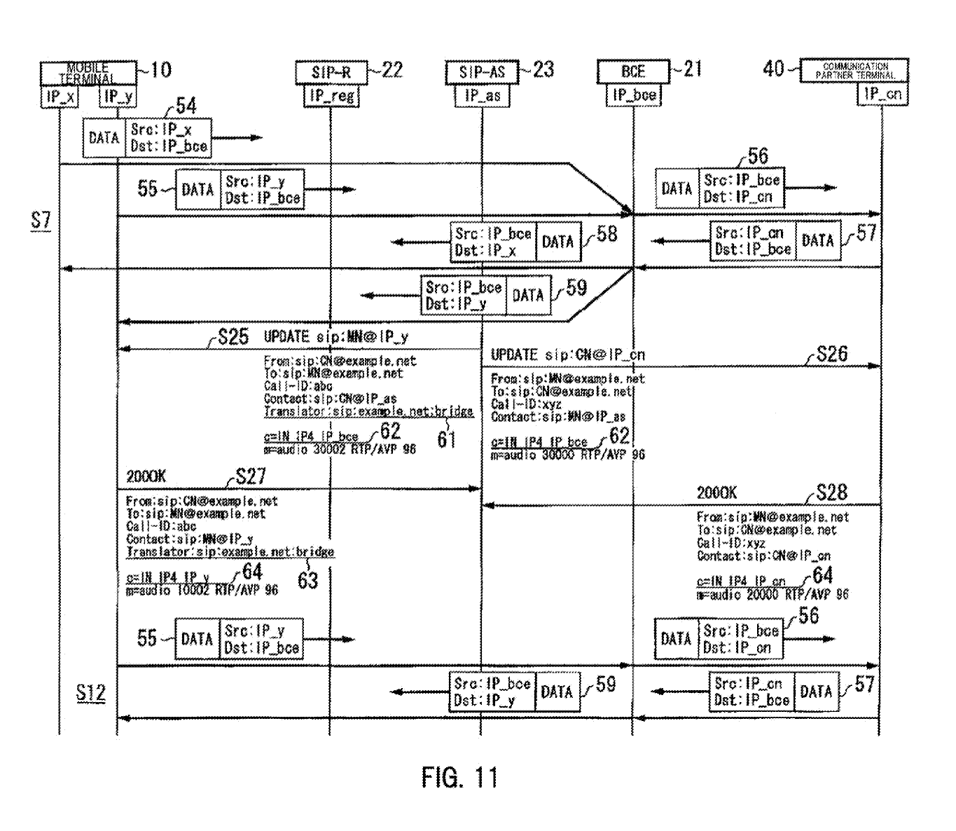

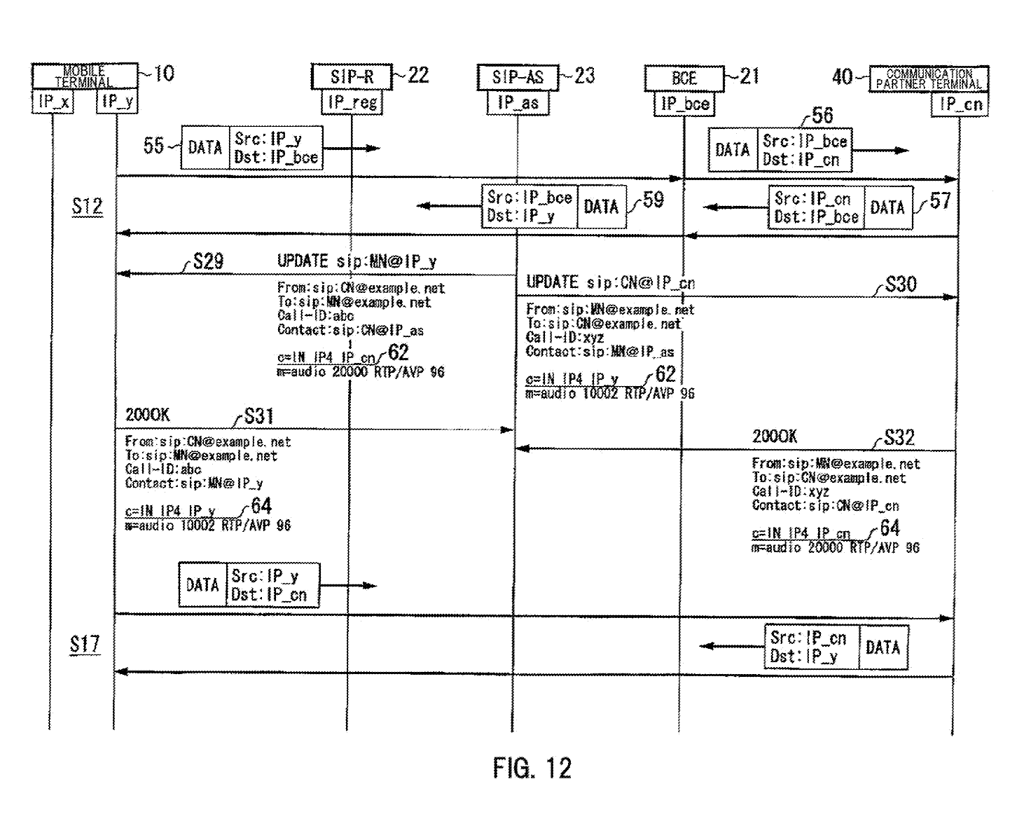

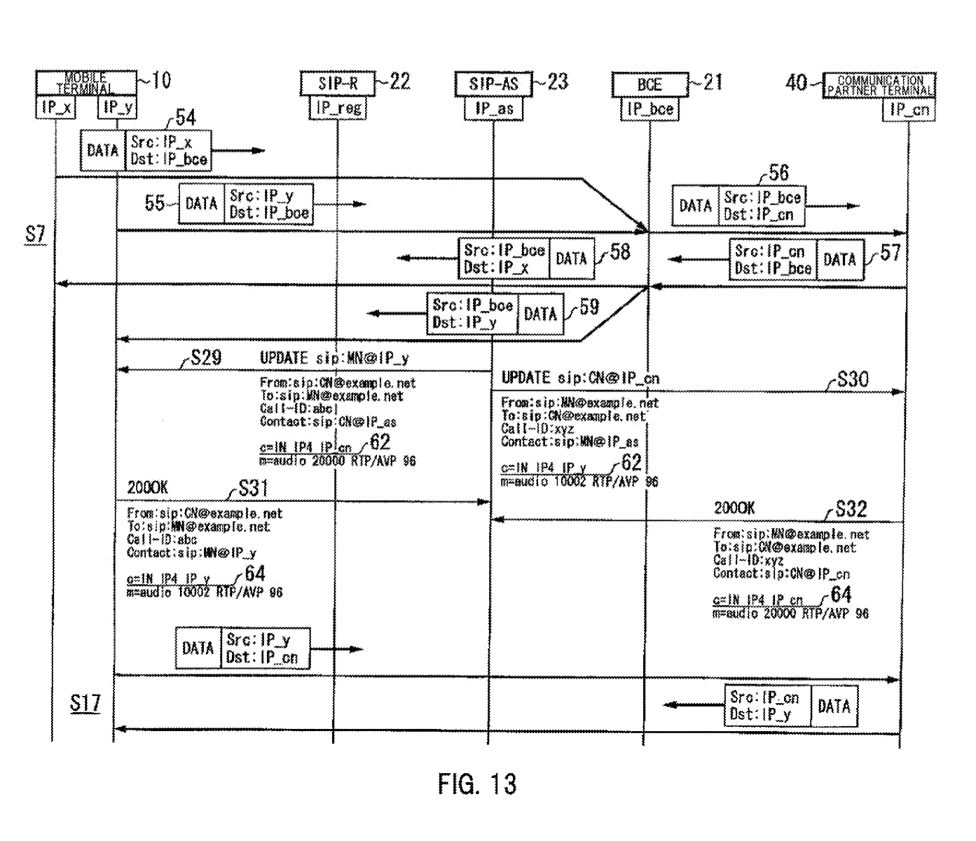

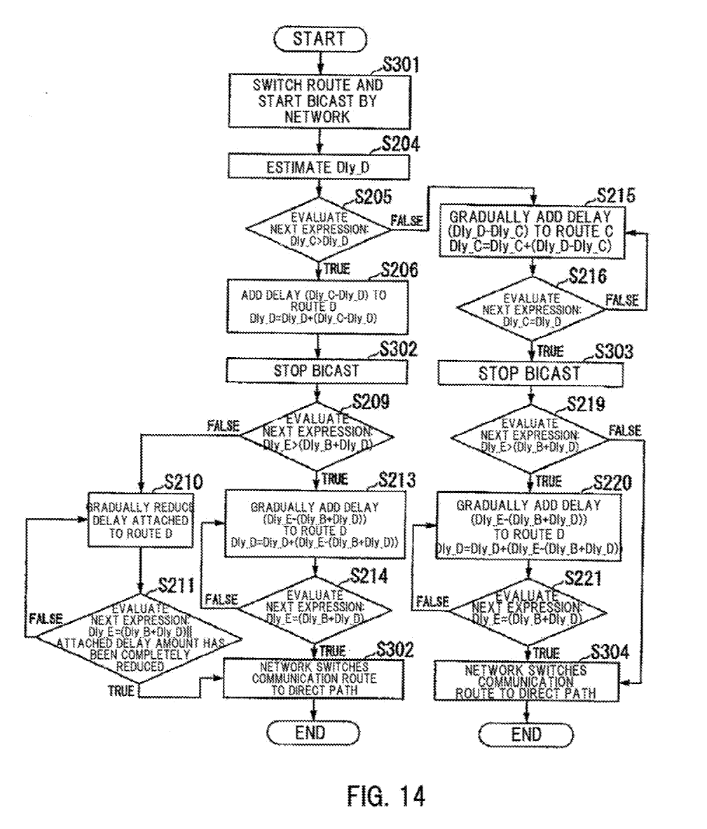

Also, although the above described embodiment has a terminal driven configuration in which the route switching and the bicast start/stop are launched by the UPDATE message from the mobile terminal (MN), it may have a network driven configuration in which the launch is performed by signaling from the network. FIGS. 10 to 13 show sequence diagrams in the network driven case, and FIG. 14 shows a flowchart of a handover procedure in the network driven case, respectively. FIGS. 10 to 13 correspond to the above described FIGS. 4 to 7, and FIG. 14 corresponds to the above described FIG. 9 respectively, and the same reference characters are attached to respective corresponding parts. As shown in FIGS. 10 to 13, in the network driven case, the route switching and the bicast start/stop are launched by the UPDATE message from the SIP-AS 23 (steps S21 to S32). Similarly in FIG. 14, the procedure is performed in a network driven manner (steps S301 to S304).

It should be noted that, in FIGS. 10 to 13, “Translator” header fields 61 and 63 are provided in the UPDATE message and its response, that is, the 200OK message between the MSs, respectively, and the string “bicast” indicating that the message is the bicast request or the string “bridge” indicating that the message is the bicast stop request is stored therein. In addition, “c” fields 62 and 64 in the UPDATE message and the 200OK message respectively are used to inform the IP address.

It should be noted that, in the above described first embodiment, although the BCE 21 is provided only in the communication system 20X before the handover, of the two communication systems 20X and 20Y before and after the handover, the BCE 21 can also be similarly provided only in the communication system 20Y after the handover.

### Second Embodiment

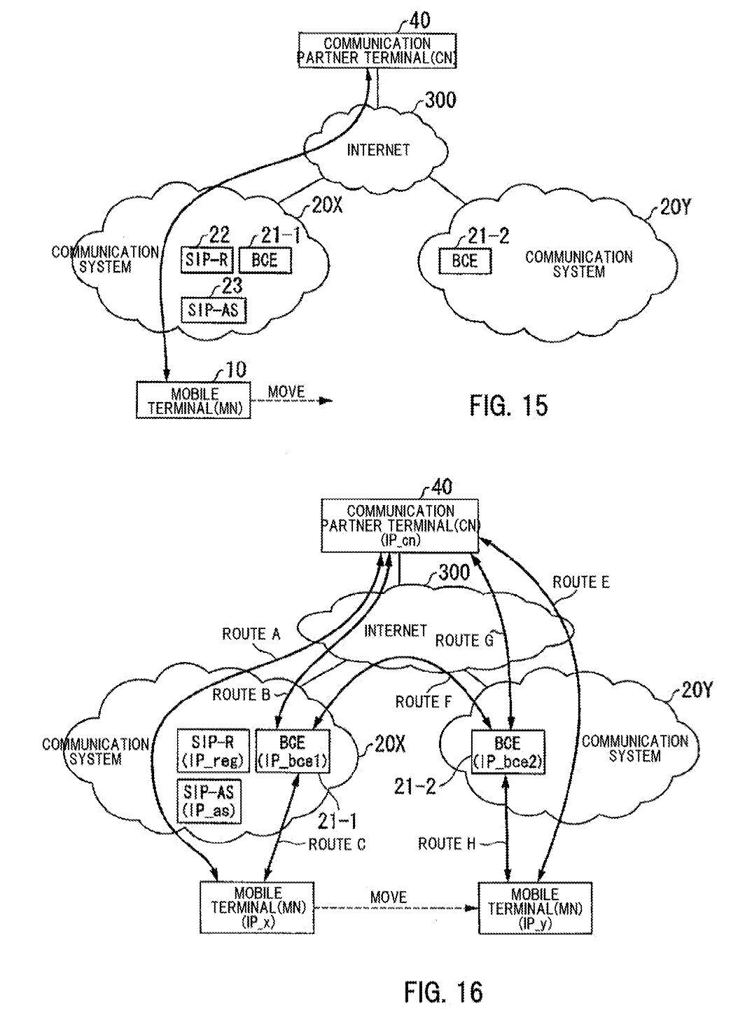

FIG. 15 is a block diagram showing a general configuration of a communication system according to a second embodiment of the present invention.

In the above described first embodiment, the bicast entity (BCE) is provided in only one of the two communication systems before and after the handover, while in the second embodiment, the BCE is provided in both of the communication systems before and after the handover.

FIG. 15 is the block diagram showing the general configuration of the communication system according to the second embodiment of the present invention. In FIG. 15, similarly to the configuration of FIG. 1, the communication system 20X has a BCE 21-1, the SIP-R 22 and the SIP-AS 23. On the other hand, the communication system 20Y has a BCE 21-2.

In FIG. 15, similarly to the system of FIG. 1, the mobile terminal (MN) 10 has the communication interfaces for both of the communication systems 20X and 20Y to connect to the communication systems 20X and 20Y, so that the MN 10 can communicate with the communication partner terminal (CN) 40 connected to the Internet 300, for example. Moreover, when the handover is performed between the communication systems 20X and 20Y, the MN 10 can connect to both of the communication systems 20X and 20Y to continue the communication.

Also similarly to the first embodiment, for convenience of explanation, it is assumed that, in the MN 10, the IP address of the communication interface for the communication system 20X (MN 10_X) is IP_x, and the IP address of the communication interface for the communication system 20Y (MN 10_Y) is IP_y. Also, it is assumed that an IP address of the BCE 21-1 is IP_bce1, an IP address of the BCE 21-2 is IP_bce2, the IP address of the SIP-R 22 is IP_reg, the IP address of the SIP-AS 23 is IP_as, and the IP address of the CN 40 is IP_cn. In addition, it is assumed that the SIP URI (SIP Uniform Resource Identifier) of the MN 10 is “MN@example.net”, and the SIP URI of the CN 40 is “CN@example.net”. Moreover, the CN 40 is the legacy terminal implemented with the SIP.

FIG. 16 shows routes between respective nodes in a network configuration shown in FIG. 15 as described above. A communication route between the CN 40 and the MN 10_X (not via the BCE 21-1) is a route A, a communication route between the CN 40 and the BCE 21-1 is a route B, a communication route between the BCE 21-1 and the MN 10_X is a route C, a communication route between the CN 40 and the MN 10_Y (not via the BCE 21-2) is a route E, a communication route between the BCE 21-1 and the BCE 21-2 is a route F, a communication route between the CN 40 and the BCE 21-2 is a route G, and a communication route between the BCE 21-2 and the MN 10_Y is a route H. Moreover, respective delay times in the routes A, B, C, E, F, G and H are Dly_A, Dly_B, Dly_C, Dly_E, Dly_F, Dly_G and Dly_H.

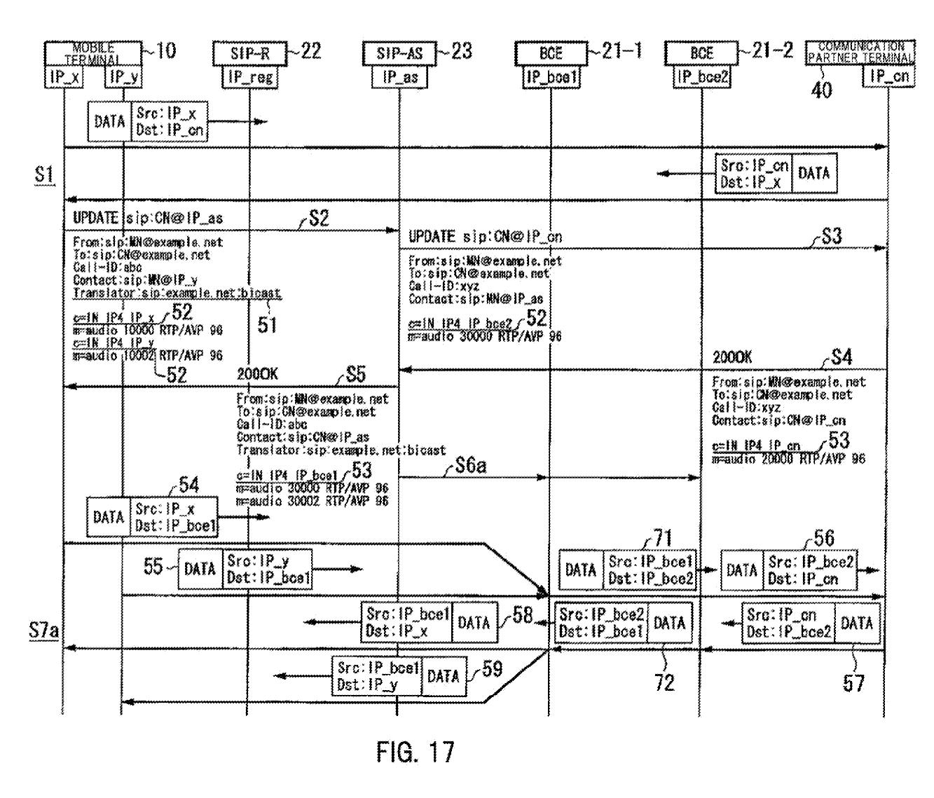

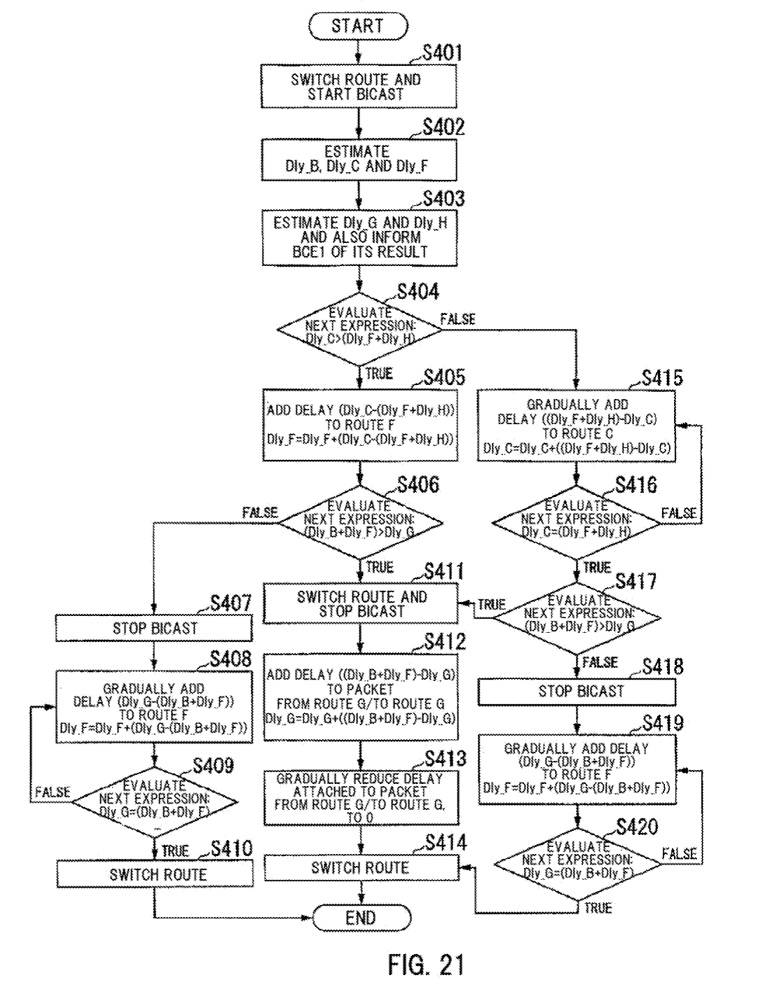

Next, with reference to FIG. 16 and FIGS. 17 to 21, operations according to the second embodiment will be described. FIGS. 17 to 20 are process sequence diagrams among the devices according to the second embodiment, and FIG. 21 is a flowchart showing a handover procedure according to the second embodiment. It should be noted that the same reference characters are attached to the parts in FIGS. 17 to 20 corresponding to the respective parts in FIGS. 4 to 7. Also, in the second embodiment, with respect to similar processes as the first embodiment, the description thereof is omitted.

In FIG. 16, the MN 10 first connects to the communication system 20X to communicate with the CN 40 through the route A, then performs the handover for switching the network to connect from the communication system 20X to the communication system 20Y, and continues the communication with the CN 40 via the communication system 20Y. The operation related to this handover will be described below.

First, according to the similar procedure as the first embodiment (see FIG. 3), the MN 10 uses the communication system 20X to establish the session with the CN 40, and is performing the communication by using the communication application such as the IP videophone (step S1 in FIG. 17). At this point, in the packet sent from the MN 10, the sender address is IP_x and the destination address is IP_cn. Also, in the packet sent from the CN 40, the sender address is IP_cn and the destination address is IP_x.

At this point, if the handover is expected to occur, for example, due to the handover trigger from the link layer, the handover instruction from the network or the like, the MN 10 starts the bicast using the BCEs 21-1 and 21-2, according to the procedure (steps S2 to S6a) shown in FIG. 17 (step S401 in FIG. 21).

In FIG. 17, the MN 10 sends the UPDATE message including the string “bicast” in its “Translator” header field 51 as the bicast request, to the SIP-AS 23 (step S2). The SIP-AS 23 instructs the BCEs 21-1 and 21-2 to start the bicast destined for the IP addresses (in this case, destined for both of the addresses IP_x and IP_y) described in the “c” fields 52 in the UPDATE message (step S6a). This establishes the bicast state. Also, when the SIP-AS 23 sends the above described UPDATE message to the CN 40 (step S3), the SIP-AS 23 integrates the “c” fields 52 into one field and stores IP_bce2 as its IP address therein. Also similarly, when the SIP-AS 23 receives the 200OK message which is the response with respect to the above described UPDATE message (step S4), the SIP-AS 23 modifies the IP address described in the “c” field 53 in the above described 200OK message to IP_bce1, and sends the message to the MN 10 (step S5).

Next, the MN 10 reproduces the packet. With respect to the one packet 54, the MN 10 sets its sender IP address to IP_x and its destination IP address to IP_bce1 and sends the packet from the MN 10_X. With respect to the other packet 55, the MN 10 sets its sender IP address to IP_y and its destination IP address to IP_bce1 and sends the packet from the MN 10_Y.

When the BCE 21-1 receives these packets 54 and 55, the BCE 21-1 modifies the sender address to IP_bce1 and the destination address to IP_bce2 in the packets 54 and 55, and sends a modified packet 71 to the BCE 21-2. At this point, the BCE 21-1 sends the packet which has arrived first, and discards the same packet which has arrived later. For example, this discarding process can be realized by discriminating whether or not they are the same packet by referring to the sequence number in the RTP header and the like.

Next, with respect to the packet 71 sent from the BCE 21-1, the BCE 21-2 modifies the sender address to IP_bce2 and the destination address to IP_cn, and sends the modified packet 56 to the CN 40.

On the other hand, in the packet 57 sent from the CN 40, the sender address is IP_cn and the destination address is IP_bce2. When the BCE 21-2 receives the packet 57 sent from the CN 40, the BCE 21-2 modifies the sender address to IP_bce2 and the destination address to IP_bce1 in the above described packet 57, and sends a modified packet 72 to the BCE 21-1.

Next, the BCE 21-1 reproduces the packet 72 sent from the BCE 21-2. With respect to the one packet 58, the BCE 21-1 sets its sender address to IP_bce1 and its destination address to IP_x, and with respect to the other packet 59, sets its sender address to IP_bce1 and its destination address to IP_y. Then the BCE 21-1 sends the packets to the MN 10 respectively.

This establishes the bicast state between the MN 10 and the CN 40 in which two communication routes, that is, the communication route using the routes B and C and the communication route using the routes B, F and H are established (step S7a in FIG. 17).

Next, the BCE 21-1 calculates Dly_B, Dly_C and Dly_F from the measurement (step S402 in FIG. 21). Also the BCE 21-2 calculates Dly_G and Dly_H from the measurement, and informs the BCE 21-1 of the calculation result (step S403 in FIG. 21).

Next, the BCE 21-1 compares Dly_C with “Dly_F+Dly_H” (step S404 in FIG. 21). As a result of the comparison at step S404, if Dly_C is greater than “Dly_F+Dly_H” (TRUE at step S404), the BCE 21-1 controls the packet transmission so that the delay time of “Dly_C-(Dly_F+Dly_H)”, which is a difference between them, is attached to the packet to be sent to the route F (step S405 in FIG. 21). This sets the delay time from the BCE 21-1 through the route C until arriving at the MN 10_X equal to the delay time from the BCE 21-1 through the routes F and H until arriving at the MN 10_Y.

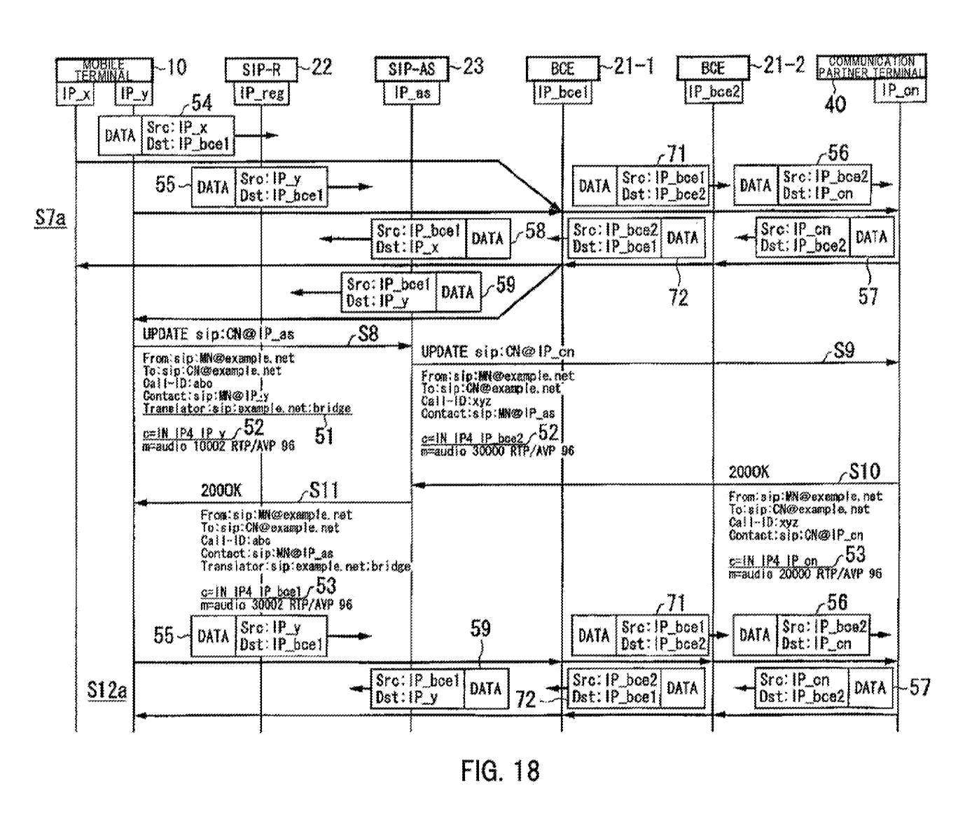

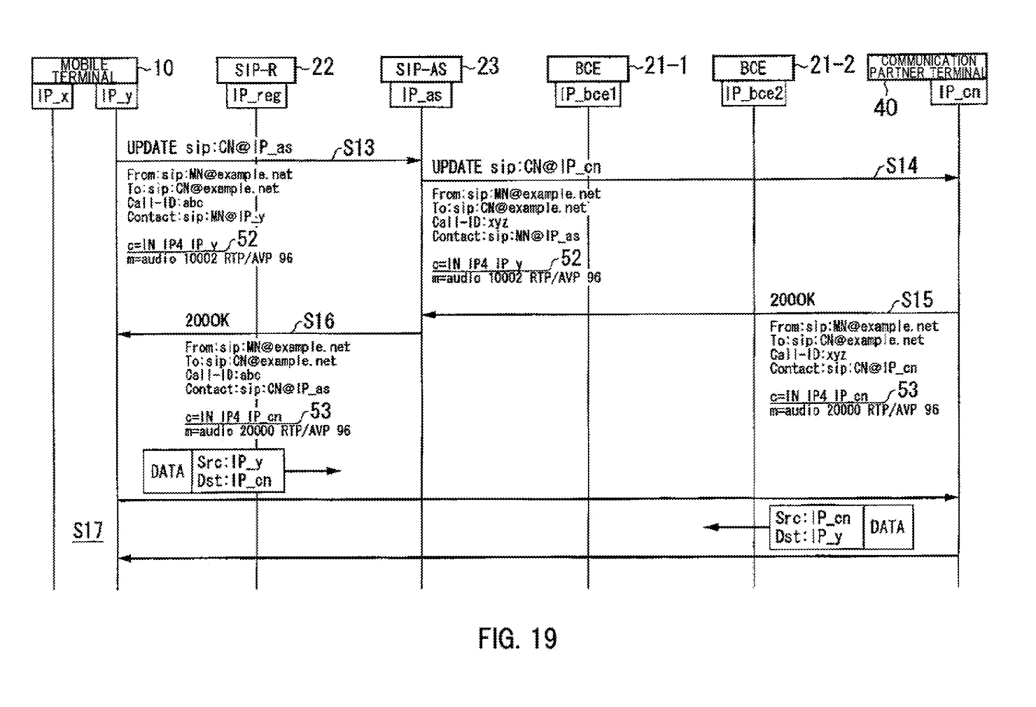

Next, the BCE 21-1 compares “Dly_B+Dly_F” with Dly_G (step S406 in FIG. 21). As a result of the comparison at step S406, if “Dly_B+Dly_F” is less than Dly_G (FALSE at step S406), the BCE 21-1 stops the bicast using the BCEs 21-1 and 21-2, according to the procedure (steps S8 to S11) shown in FIG. 18 (step S407 in FIG. 21), similarly to the first embodiment (see FIG. 5).

This changes the state between the MN 10 and the CN 40 from the bicast state in which two communication routes, that is, the communication route using the routes B and C and the communication route using the routes B, F and H are established, to a state in which only the communication route using the routes B, F and H is established (step S12a in FIG. 18).

Next, the BCE 21-1 controls the packet transmission so that “Dly_G-(Dly_B+Dly_F)” is gradually attached to the packet to be sent to the route F, until “Dly_B+Dly_F” becomes equal to Dly_G (steps S408 and S409 in FIG. 21). As a result, when “Dly_B+Dly_F” becomes equal to Dly_G, similarly to the first embodiment (see FIG. 6), according to the procedure (steps S13 to S16) shown in FIG. 19, the communication route is switched to the direct route (route E) between the CN 40 and the MN 10_Y (step S410 in FIG. 21).

This changes the state between the MN 10 and the CN 40 from the state in which the communication route using the routes B, F and H is established, to the state in which the direct route with the route E is established (step S17 in FIG. 19).

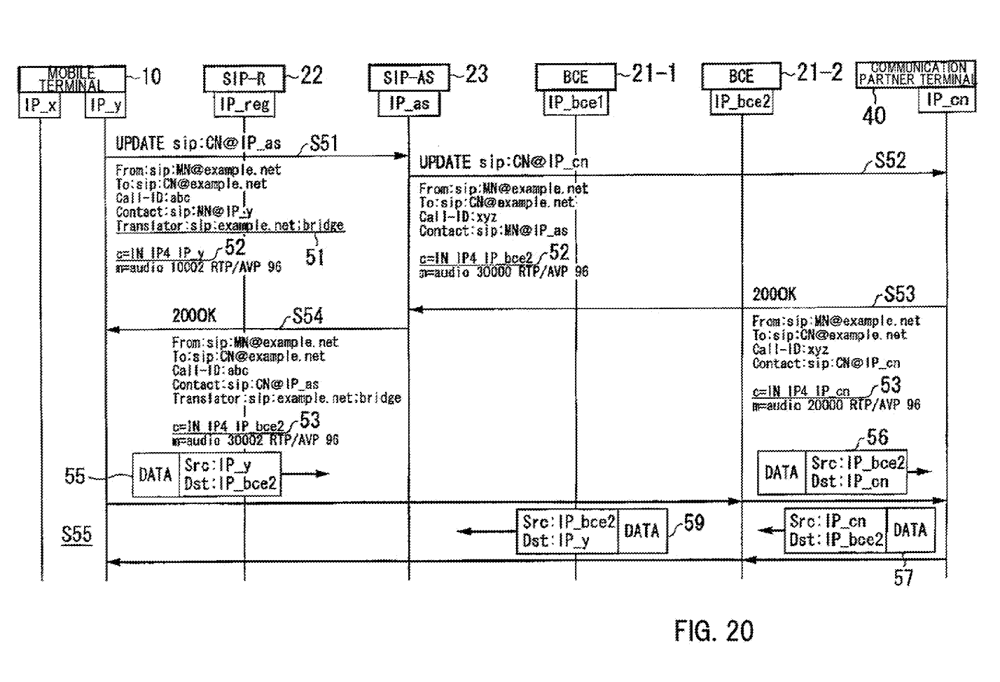

On the other hand, as the result of the comparison at step S406, if “Dly_B+Dly_F” is greater than Dly_G (TRUE at step S406), the BCE 21-1 stops the bicast according to the procedure (steps S51 to S54) shown in FIG. 20 and also switches the communication route between the CN 40 and the MN 10_Y to the route consisting of the routes G and H (step S411 in FIG. 21).

In FIG. 20, the MN 10 sends the UPDATE message including the string “bridge” in its “Translator” header field 51 as the bicast stop request, to the SIP-AS 23 (step S51). When the SIP-AS 23 sends the above described received UPDATE message to the CN 40 (step S52), the SIP-AS 23 modifies the IP address described in the “c” field 52 to IP_bce2. Also similarly, when the SIP-AS 23 receives the 200OK message which is the response with respect to the above described UPDATE message (step S53), the SIP-AS 23 modifies the IP address described in the “c” field 53 in the above described 200OK message to IP_bce2, and sends the message to the MN 10 (step S54).

This changes the state between the MN 10 and the CN 40 from the bicast state in which two communication routes, that is, the communication route using the routes B and C and the communication route using the routes B, F and H are established, to the state in which only the communication route using the routes G and H is established (step S55).

Also, simultaneously with the above described switching to the routes G and H, the BCE 21-2 controls the packet transmission so that “(Dly_B+Dly_F)-Dly_G” is attached to the packet to be sent from the route G to the route H and the packet to be sent from the route H to the route G (step S412 in FIG. 21). Next, the BCE 21-2 gradually reduces the delay which the BCE 21-2 has attached to the packets at step S412, to eliminate the above described attached delay (step S413 in FIG. 21). Next, similarly to the above described step S410, the BCE 21-2 switches the communication route to the direct route (route E) between the CN 40 and the MN 10_Y (step S414 in FIG. 21).

In the case where Dly_C is less than “Dly_F+Dly_H” in the comparison result at step S404 (FALSE at step S404)]

The BCE 21-1 controls the packet transmission so that the delay time of “(Dly_F+Dly_H)-Dly_C” is gradually attached to the packet to be sent to the route C (steps S415 and S416 in FIG. 21). This sets the delay time from the BCE 21-1 through the route C until arriving at the MN 10_X equal to the delay time from the BCE 21-1 through the routes F and H until arriving at the MN 10_Y.

Next, the BCE 21-1 compares “Dly_B+Dly_F” with Dly_G (step S417 in FIG. 21). As a result of the comparison at step S417, if “Dly_B+Dly_F” is greater than Dly_G (TRUE at step S417), the procedure proceeds to step S411.

On the other hand, as the result of the comparison at step S417, if “Dly_B+Dly_F” is less than Dly_G (FALSE at step S417), the BCE 21-1 stops the bicast using the BCEs 21-1 and 21-2, similarly to step S407 (step S418 in FIG. 21). This changes the state between the MN 10 and the CN 40 from the bicast state in which two communication routes, that is, the communication route using the routes B and C and the communication route using the routes B, F and H are established, to the state in which only the communication route using the routes B, F and H is established (step S12a in FIG. 18).

Next, the BCE 21-1 controls the packet transmission so that “Dly_G-(Dly_B+Dly_F)” is gradually attached to the packet to be sent to the route F until “Dly_B+Dly_F” becomes equal to Dly_G (steps S419 and S420 in FIG. 21). As a result, when “Dly_B+Dly_F” becomes equal to Dly_G, the procedure proceeds to step S414. This changes the state between the MN 10 and the CN 40 from the state in which the communication route using the routes B, F and H is established, to the state in which the direct route with the route E is established (step S17 in FIG. 19).

According to the above described second embodiment, when the handover is performed by using the bicast entities provided in both of the two communication systems before and after the handover, it is possible to limit the usage of the communication route via the bicast entity to the temporary usage during the handover, and perform the communication by using the optimal communication route not via the bicast entity after the handover is completed. This improves the redundancy of the communication route in the case of realizing the continuation of the communication by performing the handover between the different communication systems.

Moreover, similarly to the first embodiment, evaluation of the delay time before and after switching the communication route, and adjustment of the delay time difference can prevent the inversion of the packet arrival order and also reduce the rapid change in the delay time.

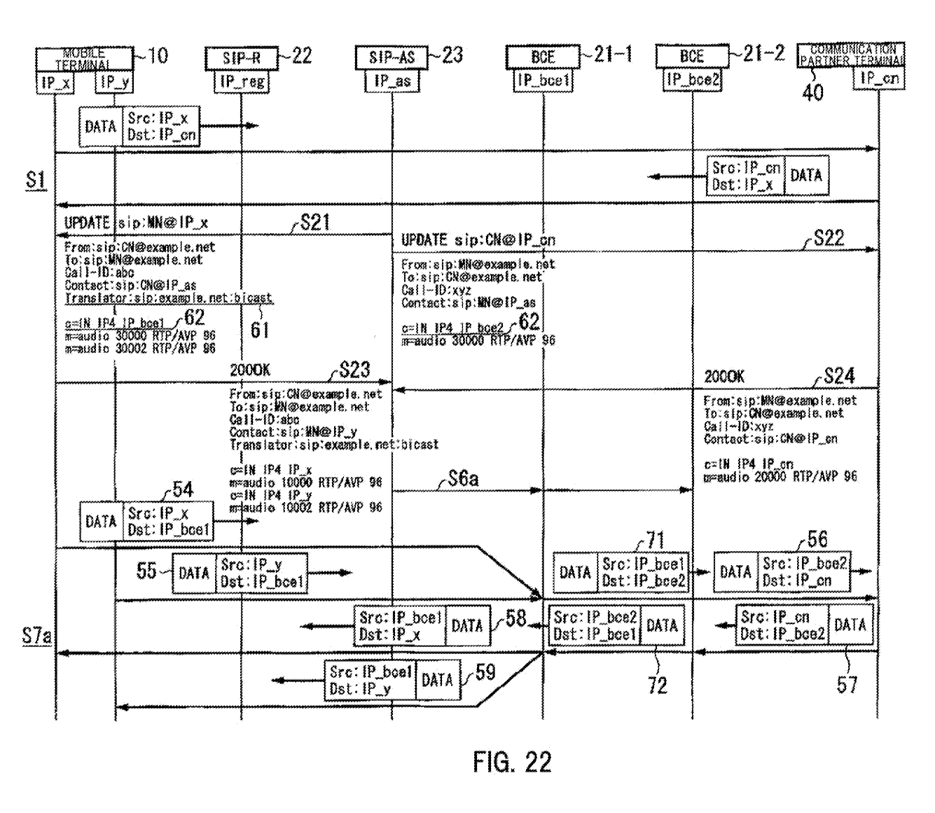

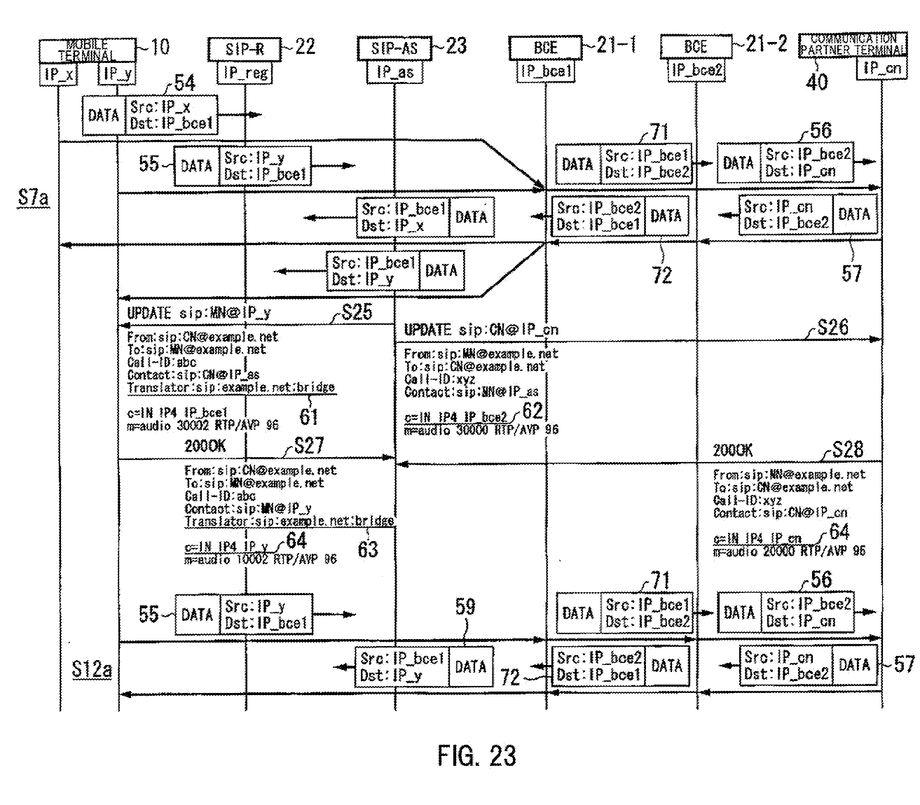

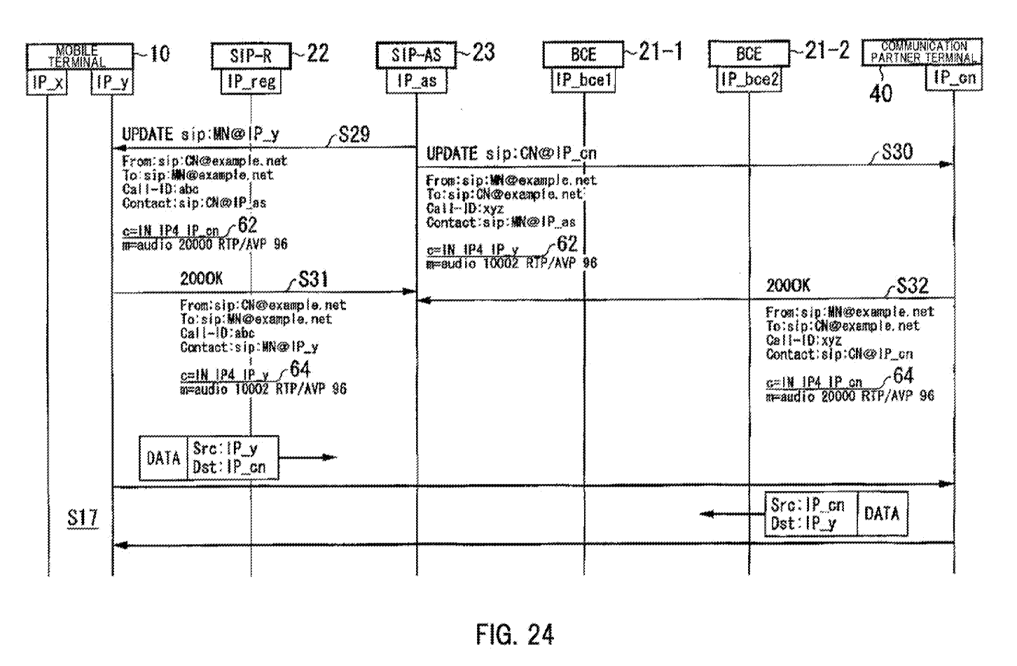

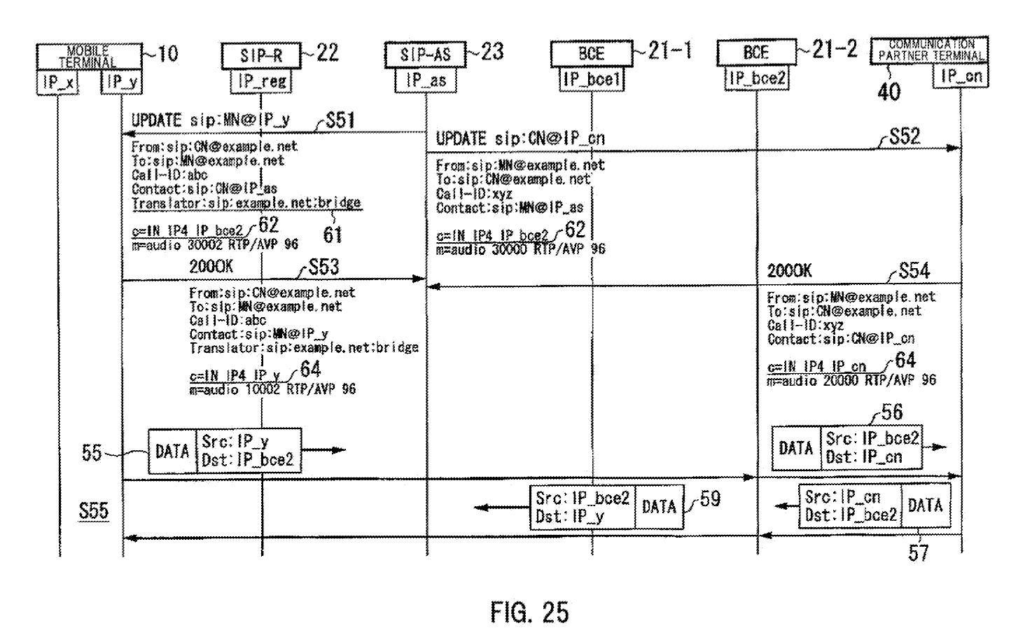

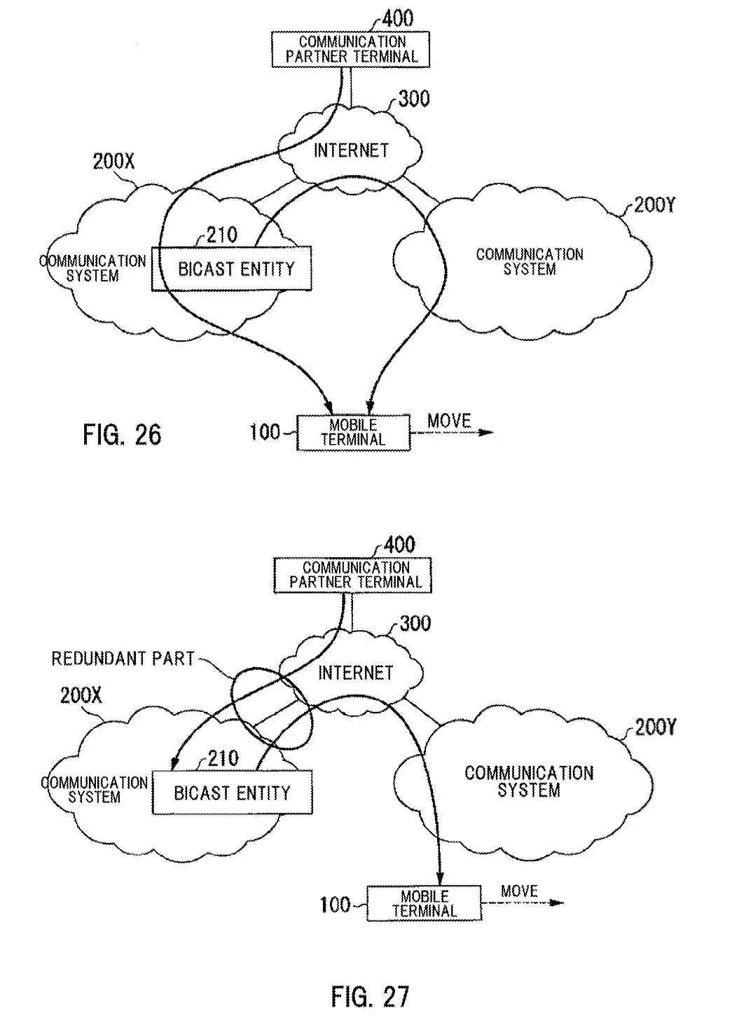

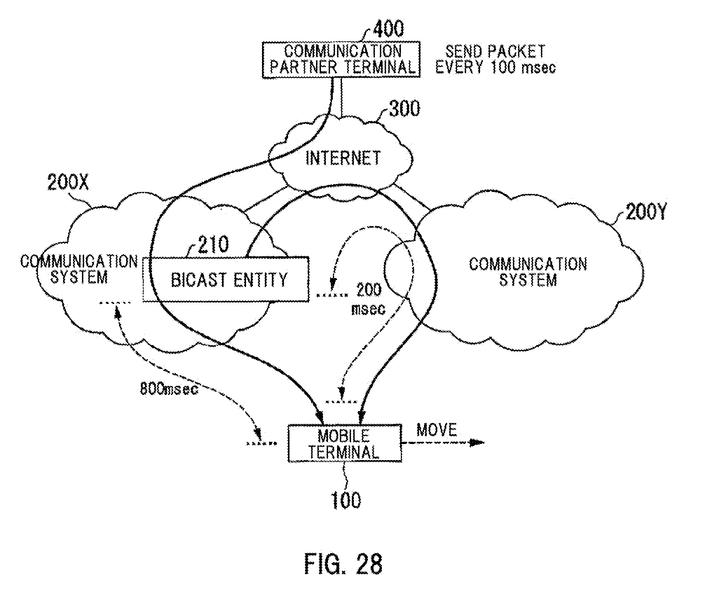

It should be noted that, although the above described second embodiment has the terminal driven configuration in which the route switching and the bicast start/stop are launched by the UPDATE message from the mobile terminal (MN), it can also have the network driven configuration in which the launch is performed by the signaling from the network, similarly to the first embodiment (see FIGS. 10 to 13). FIGS. 22 to 25 show sequence diagrams in the network driven case. FIGS. 22 to 25 correspond to the above described FIGS. 17 to 20, and the same reference characters are attached to corresponding parts. Also, the same reference characters are attached to the parts corresponding to the respective parts in FIGS. 10 to 13.

As shown in FIGS. 22 to 25, in the network driven case, the route switching and the bicast start/stop are launched by the UPDATE message from the SIP-AS 23 (steps S21 to S32, and S51 to S54).

As described above, according to the embodiments of the present invention, when the wireless terminal makes the connection and continues the communication across the different communication systems, a smooth handover can be realized and high communication quality of the real time application and the like can be maintained.

Moreover, redundant communication routes are temporarily used during the handover, which enables effective usage of communication resources. Furthermore, the evaluation of the delay time before and after switching the communication route, and the adjustment of the delay time difference make it possible to intend to solve problems caused by the delay time difference before and after switching the communication system, by preventing the inversion of the packet arrival order, reducing the rapid change in the delay time, and the like. It should be noted that although this embodiment increases the number of times of switching the communication route in comparison to the related art, the delay adjustment of this embodiment can reduce the effect of the change in delay due to the increased number of times of switching. This enables a seamless handover between the different communication systems.

In addition, a communication control process may be performed by recording a program for realizing functions of the bicast entity (BCE) shown in FIG. 1 or FIG. 15 in a computer readable recording medium, and causing a computer system to read and execute the program recorded in this recording medium. It should be noted that “computer system” used herein may include an OS or hardware such as a peripheral device.

Moreover, “computer readable recording medium” refers to a storage device, including a writable nonvolatile memory such as a flexible disk, a magneto optical disk, a ROM and a flash memory, a portable medium such as a CD-ROM, a hard disk included in the computer system and the like.

Furthermore, “computer readable recording medium” also includes a medium for retaining the program for a certain period of time, such as a volatile memory (for example, a DRAM (Dynamic Random Access Memory)) within the computer system which becomes a server or a client in the case where the program has been sent via the network such as the Internet or a communication line such as a telephone line.

In addition, the above described program may be transmitted to another computer system from the computer system which has stored this program in the storage device and the like, via a transmission medium or through a transmission wave in the transmission medium. Here, “transmission medium” for transmitting the program refers to a medium having a function of transmitting information, such as the network like the Internet (communication network) or the communication line like the telephone line (communication wire).

Moreover, the above described program may be for realizing a part of the above described functions. Furthermore, the above described program may be a program capable of realizing the above described functions in combination with programs previously recorded in the computer system, that is, so-called a differential file (differential program).

Hereinabove, although the embodiments of the present invention have been described in detail with reference to the figures, specific configurations are not limited to the embodiments and also include design changes and the like in a range not deviating from the gist of the present invention.

What is claimed is:

1. A communication relay apparatus for, when a wireless terminal makes a connection and continues a communication across different communication systems, temporarily delivering a packet of said communication, comprising:
bicast means for delivering said packet for each communication route via each communication system before and after switching the communication system to which said wireless terminal connects; and
control means for completing a relay of said packet when the switching of the communication system to which said wireless terminal connects is completed.

2. The communication relay apparatus according to claim 1, wherein said bicast means has delay adjustment means for evaluating a delay time in each communication route before and after switching the communication system to which said wireless terminal connects, and adjusting a difference in the delay times.

3. The communication relay apparatus according to claim 2, wherein when the adjustment of said difference in the delay times has been completed, said control means reroutes to an optimal communication route via a switch destination communication system for said wireless terminal.

4. A wireless terminal for making a connection and continuing a communication across different communication systems, comprising:
communication control means for establishing, for each communication route via each communication system before and after switching the communication system, a communication route to and from a communication relay apparatus for delivering a packet,
wherein after the communication via said communication relay apparatus is performed, said communication control means reroutes to an optimal communication route via a switch destination communication system.

5. A computer program for performing a communication control process when a wireless terminal makes a connection and continues a communication across different communication systems, said computer program causing a computer to realize:
a bicast function of delivering a packet for each communication route via each communication system before and after switching the communication system to which said wireless terminal connects; and
a control function of completing a relay of a packet when the switching of the communication system to which said wireless terminal connects is completed.

6. The computer program according to claim 5, further causing the computer to realize a delay adjustment function of evaluating a delay time in each communication route before and after switching the communication system to which said wireless terminal connects, and adjusting a difference in the delay times.

7. The computer program according to claim 6, wherein when the adjustment of said difference in the delay times has been completed, said control function reroutes to an optimal communication route via a switch destination communication system for said wireless terminal.
